(19) United States
(12) Patent Application Publication
(10) Pub. No.: US 2026/0350308 A1
(43) Pub. Date: Nov. 5, 2026

(54) SUPER-INTELLIGENCE VIA UNIVERSAL LANGUAGE UNDERSTANDING

(71) Applicant: Applied General Intelligence, Inc., Austin, TX (US)

(72) Inventor: Xiaolin Zhang, Charlotte, NC (US)

(21) Appl. No.: 19/643,638

(22) Filed: Apr. 9, 2026

Related U.S. Application Data
(63) Continuation of application No. PCT/US2024/051017, filed on Oct. 11, 2024.
(60) Provisional application No. 63/589,829, filed on Oct. 12, 2023.
(60) Provisional application No. 63/559,049, filed on Feb. 28, 2024.

(51) Int. Cl. G06F 40/211; G06F 16/901; G06F 40/289

(52) U.S. Cl. CPC G06F 40/211; G06F 16/9024; G06F 40/289

(57) ABSTRACT

Disclosed herein are computer-implemented methods of providing universal language understanding, the computer-implemented method including parsing an input in a language domain into an enriched tree data-structure, wherein the enriched tree data-structure comprises at least one of a unique identification of an entity, a classification, and a resolution; processing the enriched tree data-structure by matching the enriched tree data-structure with one or more dynamic language graphs, wherein the one or more dynamic language graphs store a relation between elements of the language domain, a causation of the entities, and a property of the entities; and upon determining the enriched tree data-structure does not match with the one or more dynamic language graphs, at least a portion of the enriched tree data-structure that does not match is inserted into the one or more dynamic language graphs.

### CROSS-REFERENCE

This application is a continuation of International Application No. PCT/US2024/051017, filed Oct. 11, 2024, which claims benefit of U.S. Provisional Application No. 63/589,829, filed Oct. 12, 2023, and U.S. Provisional Application No. 63/559,049, filed Feb. 28, 2024, each of which are incorporated in their entirety herein by reference.

### BACKGROUND

A mechanism for natural language understanding that provides verifiable, grounded, coherent output is foundational to the establishment of reliable, trustworthy intelligent systems. Developing such a mechanism for natural language understanding that adheres to the law of coherence is a significant challenge in the realm of computational intelligence.

### SUMMARY

In an aspect disclosed herein is a computer-implemented method of providing universal language understanding, the computer-implemented method comprising: (a) parsing an input in a language domain into an enriched tree data-structure, wherein the enriched tree data-structure comprises at least one of a unique identification of an entity, a classification, and a resolution; (b) processing the enriched tree data-structure by matching the enriched tree data-structure with one or more dynamic language graphs, wherein the one or more dynamic language graphs store a relation between elements of the language domain, a causation of the entities, and a property of the entities; and (c) upon determining the enriched tree data-structure does not match with the one or more dynamic language graphs, at least a portion of the enriched tree data-structure that does not match is inserted into the one or more dynamic language graphs.

In some embodiments, the relation is defined as a tuple of entities and relations. In some embodiments, the entities are basic elements of an ontology of the language domain. In some embodiments, the computer-implemented method further comprises chunking the input into a plurality of chunks based at least in part on a dictionary model of the language domain. In further embodiments, the computer-implemented method further comprises parsing the plurality of chunks leveraging an initial grammar rule. In some embodiments, the at least portion of the enriched tree data-structure inserted into the one or more dynamic language graphs comprises a new grammar rule, a new causation between entities, a new property, or a new relationship.

In an aspect disclosed herein is a computer-implemented method of coherent natural language understanding comprising: (a) receiving an input and generating one or more parsed inputs using a parsing and chunking engine, wherein the one or more parsed inputs comprises a plurality of entities, wherein the plurality of entities comprises one or more words, one or more characters, or one or more collections of words, and wherein each of the one or more parsed inputs comprise an enriched data-tree structure; (b) matching at least one of the one or more parsed inputs with at least a portion of the one or more dynamic language graphs, wherein the one or more dynamic language graphs is connected to zero or more graphs of the one or more dynamic language graphs; and (c) upon failing to match at least one of the one or more parsed inputs with the one or more dynamic language graphs, inserting one or more portions of at least one of the one or more parsed inputs into one or more of the dynamic language graphs or generating a new dynamic language graph comprising one or more portions of the one or more parsed inputs.

In some embodiments, the one or more dynamic language graphs comprise a representation of natural language, the representation comprising the plurality of entities or a grammar, wherein the grammar comprises constructions of organization of the of the plurality of entities. In further embodiments, the input provides a new grammar rule. In further embodiments, the representation of natural language is derived from a low-resource corpus. In still further embodiments, the low-resource corpus comprises human languages, symbolic languages, business documentation, or aggregate text corpora. In some embodiments, the one or more dynamic language graphs comprise representations of one or more causations of each of the plurality of entities, wherein the representations comprise a provenance of each of the plurality of entities, properties of each of the plurality of entities, or relationships among each of the plurality of entities. In some embodiments, the one or more dynamic language graphs are implemented on an SQL server. In some embodiments, calculations to maintain the one or more dynamic language graphs are performed using a compiler. In some embodiments, the one or more dynamic language graphs are optimized for fast computation and memory usage at scale. In some embodiments, the parsing engine raises and increases the size of the plurality of entities. In some embodiments, the one or more parsed input further comprises one or more syntactic, semantic, or pragmatic relationship among the plurality of entities. In some embodiments, the computer-implemented method further comprises providing a grounded response to the input. In further embodiments, the grounded response comprises one or more source of verification. In some embodiments, the computer-implemented method further comprises receiving the input from one or more of a user device, internal input devices, external input devices, or machine-readable instructions. In some embodiments, the one or more dynamic language graphs comprise one or more systems and one or more transitions, wherein the one or more transitions comprise one or more change-rules, wherein the one or more systems comprise one or more structures and one or more relations, wherein the one or more relations comprise one or more tuples of the plurality of entities and one or more connections, wherein the one or more structures comprise one or more collections, wherein the one or more collections comprise the plurality of entities and one or more properties, wherein the one or more properties comprise one or more pairs of attributes and values. In some embodiments, the computer-implemented method further comprises selecting a dynamic language graph in which to insert the one or more parsed inputs based on TOE logic that comprises three truth elements. In some embodiments, the computer-implemented method further comprises generating a response to the input, wherein the response comprises at least one of a grounded response to the input, a request for more information, a null response, or an indication of an error in the input, referenced, and reproducible, and the grounded response is self-consistent with all prior responses to all inputs. In further embodiments, the grounded response comprises a reference to a source of verification.

In an aspect disclosed herein is a computer system, comprising: (a) a processor; (b) a display; and (c) a non-transitory computer readable storage medium encoded with a computer program that causes said processor to perform any one of the methods of any one of the preceding claims.

In an aspect disclosed herein is a non-transitory computer-readable storage media encoded with a computer program including instructions executable by a processor to create an application, the application configured to perform any one of the methods of any one of the preceding claims.

In an aspect disclosed herein is a system comprising one or more computer processors and a computer-readable memory, the computer-readable memory comprising machine-executable code that, upon execution by the one or more computer processors, implements a method for generating a grounded natural language response, said method comprising: (a) receiving, by a computing device, a natural language input; (b) selecting, from a database comprising a plurality of constructions, a construction with which to interpret the natural language input, wherein the construction is selected based on a coherence between the natural language input and the construction; (c) upon determining the construction for the natural language input, generating a grounded natural language response, wherein the grounded natural language response comprises a reference to at least one source of verification.

In some embodiments, the at least one source of verification is a website. In some embodiments, the at least one source of verification is a program documentation or an employee manual. In some embodiments, said method further comprises: (d) determining a truth value of the natural language input; (e) performing at least one action based on the truth value comprising: (i) incorporating the natural language input into the database, or (ii) requesting more information about the natural language input. In further embodiments, determining an action to perform in (e) comprises evaluating the natural language input with TOE logic. In some embodiments, the natural language input is processed by a parsing and chunking engine. In further embodiments, the parsing and chunking engine determines a plurality of entities in the natural language input. In some embodiments, the system is configured to achieve an overall score on the MMLU-Pro dataset of at least 0.78. In some embodiments, the system is configured to achieve a score of at least 0.89 in biology, 0.81 in business, 0.80 in computer science, 0.84 in economics, 0.64 in engineering, 0.77 in health, 0.64 in law, 0.82 in math, 0.77 in philosophy, 0.80 in physics, 0.81 in psychology, or any combination thereof, on the MMLU-Pro dataset. In some embodiments, generating the grounded natural language response comprises determining a question style, a theme, an entity, a domain, a task, a difficulty, a time sensitivity, a presumption, or any combination thereof, of the natural language input. In some embodiments, the grounded natural language response comprises a source of the at least one source of verification assigned to an entity of the grounded natural language response. In further embodiments, the system further comprises providing the grounded natural language response on a display of the computing device. In still further embodiments, the source of the at least one source of verification is presented on the display of the computing device. In yet further embodiments, the source of the at least one source of verification comprises a link to the source of the at least one source of verification. In some embodiments, the grounded natural language response is a translation of a first language into a second language.

In an aspect disclosed herein is a computer system comprising: (a) a game module in communication with at least one database comprising a plurality of domains of discourse, wherein each domain of discourse comprises a dynamic language graph; (b) an importing module configured to receive an input via one or more input devices; (c) a playing module configured to: (i) determine one or more domain of discourse of the plurality of domains of discourse in which to assimilate the input, and (ii) assimilate the input into the one or more domain of discourse, wherein assimilating the input comprises adding at least one entity of the input into the dynamic language graph of a domain of discourse of the one or more domain of discourse or generating a new domain of discourse comprising the entity.

In some embodiments, the system further comprises an indexing module configured to index the input into the dynamic language graph. In some embodiments, the system further comprises a recasting module configured to evaluate the input for an input efficiency. In further embodiments, the system further comprises an improvement module configured to update a portion of the plurality of domains of discourse based on the input efficiency, wherein an update to a domain of discourse of the portion of the plurality of domains of discourse comprises adding an entity to a domain of discourse of the portion or updating a relationship between at least two entities of the domain of discourse of the portion. In some embodiments, the dynamic language graph comprises data and meta-data. In some embodiments, the importing module comprises a parsing and chunking engine configured to convert the input into a parse tree. In further embodiments, the parse tree comprises the entity. In further embodiments, (c)(ii) further comprises adding the parse tree into the dynamic language graph. In some embodiments, (c)(ii) further comprises associating the entity with at least one source of verification. In further embodiments, the source of verification is a website. In further embodiments, the source of verification is a program documentation or an employee manual. In some embodiments, the playing module is further configured to generate a grounded natural language response. In some embodiments, the grounded natural language response comprises at least one source of verification assigned to an entity of the grounded natural language response. In some embodiments, the system further comprises providing the grounded natural language response on a display of a computing device. In further embodiments, the source of the at least one source of verification is presented on the display of the computing device. In still embodiments, the source of the at least one source of verification comprises a link to the source of the at least one source of verification.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of a universal learning mechanism in a games context;

FIG. 2 shows an example of universal learning mechanism in a data-flow context;

FIG. 3 shows an abstracted grounded input;

FIG. 4 shows components of an input-output embodiment of a universal learning mechanism;

FIG. 5 shows an illustrative computer system;

FIG. 6A shows a search functionality using a universal language mechanism;

FIG. 6B shows a categorical grounding of an entity in a body of text;

FIG. 6C shows an exemplary parse tree for a body of text;

FIG. 7 shows an example of a grounded input;

FIG. 8 shows an example of a universal learning mechanism for grounded response to user query;

FIG. 9 shows a Google Bard response to a user query;

FIG. 10 shows a ChatGPT-4 response to a user query;

FIG. 11 shows a grounded response with a reference to a Wikipedia;

FIG. 12 shows an example of a universal learning mechanism for use in translation;

FIG. 13A shows a ULM response to a user query;

FIG. 13B shows a ChatGPT-4 response to a user query;

FIG. 13C shows a categorical grounding of various aspects of a natural language query;

FIG. 14A shows a ULM response to a user query;

FIG. 14B shows a ChatGPT-4 response to a user query;

FIG. 14C shows a categorical grounding of various aspects of a natural language query;

FIG. 15A shows performance of a ULM on the MMLU-Pro leaderboard;

FIG. 15B shows performance of a ULM on the MMLU-Pro leaderboard;

FIG. 15C shows performance of a ULM on the MMLU-Pro leaderboard; and

FIG. 15D shows performance of a ULM on the MMLU-Pro leaderboard.

### DETAILED DESCRIPTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

Embodiments of the technologies described herein may provide solutions to problems comprising text enrichment, entity resolution, sentiment analysis, machine translation of low resource languages, document analysis for compliance standards, safety analysis, hiring analysis, product compliance analysis, and grounded, accurate, logical query-response models that may provide interpretable and verifiable responses to user queries. The verifiable responses herein may comprise references to a knowledge base used to establish the query-response model or other embodiments, or to external reference sources such as websites. In some embodiments, the solutions may comprise rich parsing and dynamic language graphs that provide scalable natural language processing that does not hallucinate responses nor require expensive specialized hardware (e.g., GPUs, TPUs, etc.). Embodiments of the solutions require no training, no data-cleaning, and all responses provided by the solutions are substantiated with sources to facilitate user verification.

### DEFINITIONS

Intelligence: intelligence as defined herein is a system's ability to maintain and enforce coherence of itself and its environment.

Grammar: grammar is a set of structured inventories of constructions, which are the basic linguistic units. Constructions vary in degrees of abstraction and have both meanings and patterns associated with them. There is a syntax-lexicon continuum.

Linguistic Style Sheet: a linguistic style sheet comprises lexicon, grammar, and subject domain.

Recasting: the concept of recasting herein refers to the modification of experiences to ensure their optimal (efficient) representation.

Coherence: the concept of coherence herein is defined as the maintenance of internal self-consistency and external relevance. The concept of coherence may be thought of as consistency and integrity, and may have spatial, temporal, and structural components.

Law of coherence: the law of coherence may be defined by three statements. First, reality is guaranteed to be coherent. Second, the only thing that is coherent with everything else is reality. Thirdly, coherence guarantees possibility.

Domain of discourse, or DD: a universal domain specification schema that is capable of describing any domain, including those with unbounded relevance. A DD may additionally be defined by the use of equivalent terminology, wherein a DD is defined as a structure of perspective.

Individual reality: The totality of DDs, which may have disjoint, embedding, and overlapping relationships to one another.

Assimilation: assimilation is a process that may be defined by a series of considerations. Assimilation mandates always making a winning move, never making a losing move, making the most efficient move from experience, which is continuously recast, improved, and indexed, and if no other option, make any legal move or surrender, which may lead to another instance of play in the same DD or an instance in a different DD, as determined by accommodation.

Accommodation: accommodation is a process of determining the appropriate DD in which to import an experience, including determining whether an appropriate DD exists.

Background: the background is the set of things that cannot be changed about a given DD. The background includes hard wired rules and change potentials that comprise boundary conditions of a given DD.

Laws: laws are the hardcoded rules (e.g., laws of physics in the real world, or the rules of chess in a computer software form of chess) that govern their relative domains—the only law that governs all domains is the law of coherence. Laws are rules-in-effect, meaning that they are self-enforced.

Language instruction: a language instruction herein refers to an input into a universal learning mechanism. A language instruction may be alternatively referred to as an input, natural language input, utterance, or experience.

Dynamic language graph: a dynamic language graph herein refers to a representation of data that has a structure that may change over time. A dynamic language graph may be alternatively referred to as a spatio-temporal graph.

### Universal Language and Language Games

In some embodiments, intelligence (or general intelligence) may be defined as a system's ability to maintain and enforce the coherence of itself and its environment. Coherence may comprise internal self-consistence and external relevance. Super-intelligence (or super-human intelligence) may be the result of natural growth of intelligence.

Intelligence may be described by three dynamically intertwined aspects, and they are: Sentio, which may be described as perceiving, seeing, sensing, feeling or other ways of taking in input; Cogito, which may be described as thinking, knowing, understanding or other ways of mental processing; Facio, which may be described as doing, acting, answering, making, causing, creating or other ways of effecting the environment.

Universal Language (UL) may be divided into Intuitive Language (IL) and Symbolic Language (SL). SL may be further divided into Fixed Language (FL) and Natural Language (NL). IL includes all kinds of sensory data, whose interpretation (e.g., the mapping between the surface structure and meaning) may be isomorphic. SL may include all other cases where the interpretation may not be necessarily isomorphic. Thus, IL may be considered as a restricted case of SL. FL includes all mathematical language, whose interpretation may be fixed and universally accepted. NL may include all other cases. Thus, FL may be considered as a restricted case of NL.

Creating a super-intelligent system may be equivalent to creating a system that understands Universal Language, both in theory and in practice. Herein, NL understanding may be equivalent to UL understanding. In short intelligence as defined herein may be considered as equivalent to natural language understanding.

### High Level Description

Taking insights from programming languages, language may be viewed on three distinct levels: its form, its function, and its effect. Its form may comprise language's appearance: texts, symbols, images, gestures, sounds etc. Its function may comprise what language says: interpreted instructions understandable by its intended target (e.g., machine code). Its effect may comprise what language does: the causal effect of the execution of its function. The effect of language provides the ultimate grounding for its meaning.

More specifically, the following may comprise novel perspectives of the natural language understanding (NLU) problem: (1) Instead of a single system with fixed grammar and vocabulary, natural language may be regarded as a family of open systems that change fluidly over time and space. (2) Instead of information exchange, communication may be regarded as means of transporting experience, thus making language instructions to be executed on the receiver to produce experience, which provides the ultimate grounding for its meaning. (3) Experience itself may be regarded as a rich continuum that includes direct or indirect, external or internal, detailed, summarized or abstracted experience. Consequently, grammar and dictionaries may be regarded as indirect, abstracted experience.

Some embodiments of a comprehensive and coherent solution may include the following core technologies: (1) A universal domain specification schema, herein referred to as a Domain of Discourse or DD, capable of describing any domain, including those with unbounded relevance, (2) a Universal Learning Mechanism, or ULM, that may learn from experience in any domain and that may also learn the domain specifications themselves, (3) a method, herein referred to as TOE logic, of determining when and how to change the underlying DD for language understanding, and (4) specifications of the language domain as language games with enough rich details for implementation. Such core technologies may be implemented using computer systems as described herein.

### Technologies

In some embodiments of a ULM solving NLU, an agent may be required to possess the dual capabilities of understanding languages within any specific DD and of understanding in which DD the languages are to be understood. The present disclosure provides a universal domain specification schema and specifications of the universal language games (e.g., decision making implementation) with enough details thereby successfully implementing these dual capabilities. In an aspect of the present disclosure, a universal domain specification schema and a universal learning mechanism may be provided to address each of the above tasks.

A universal domain specification schema (DD) may be a self-driven dynamic environment. In some embodiments, a DD may comprise five sets of elements: Entities, Laws, Background, Players, and Goals. In some cases, the multiple sets of elements may also be referred to as game pieces, game rules, game board, game players and game goals. Each instance of playing may be direct, detailed experience corresponding to the DD. In some cases, other type of experience may be imported to further accelerate or supplement the method herein.

Rather than as auxiliary labels, DDs may implement time as rhythm, space as background in each DD, making their presence ubiquitous. Time is generally incommensurable between DDs, unless overlapping demands synchronization and coordination among two or more DDs. Causality may be realized as the combination of player's moves, current state, timing and all other elements in each DD. Initially, there may be three fundamental DDs: DD of Domains (the DD game), DD of universal language, and Generally Accepted Common Reality (GACR), which may be each agent's subjectively constructed objective world. The totality of an agent's DDs including their experience may be referred to as the agent's Individual Reality (IR). In some cases, the IR may be represented by a plurality of dynamic language graphs disposed on a plurality of databases. Coherence, the essence of intelligence, may be innately maintained through the enforcement of each DD, further constrained by the overlapping between them. In some embodiments, there may be three aspects of coherence comprising: spatial, temporal and structural. Different DDs may have overlapping, embedding or disjoint relations to each other and the overlapping part may be any of DD's five elements.

In some embodiments, a universal learning mechanism (ULM) may achieve universal learning through two intertwined processes: assimilation, which comprises learning within one DD, and accommodation, which comprises determining the right DD for assimilation to occur. In some embodiments of assimilation, ULM may take the current DD, all its experience, and the current instance as input (e.g., experience, language instructions) to produce the next move in the current DD. In accommodation, which may occur in the DD game, the accommodation process may use the same input to produce a new DD, which may be a modification of an existing DD or an entirely new DD. The TOE logic, described below, may be implemented to determine the dynamic interplays between assimilation and accommodation.

In some embodiments, only assimilation may be needed in learning in any specific domain, but a ULM comprising unrestricted NLU may leverage the dynamic interplay between the two processes, since the underlying topic changes frequently. Assimilation may be summarized by four considerations comprising: (1) always make a winning move, (2) never make a losing move, (3) make the most efficient move from experience, which may be continuously recast, improved, and indexed; and (4) if nothing else, make any legal move or surrender, which may give rise to another instance of play in the same DD or an instance in a different DD, determined by the accommodation process defined below. In some embodiments, the definitions for winning, losing, and legal moves may be determined by the current DD, wherein the DD itself may be a part of the input parameters of ULM. Note that making a winning move may be analogous to making the most efficient possible move—the incorporation of an inefficient move or set of moves does not constitute a win. In other words, a move not taken may be considered a losing move (e.g., inefficient) if the move would have resulted in a win. This logic ensures that later inference may not return a false winning strategy as inefficient moves will not be incorporated.

In some embodiments accommodation may include playing the DD game, which may be summarized as follows: (1) the Entities of the DD game may be other DDs, (2) the single Player of the DD game may be Self, (3) the Background of the DD game may be the Law of Coherence, (4) the Goal of the DD game may be to produce a new DD that may be coherent with all existing experience but yields a non-losing outcome for the current instance, and (5) the DD game may be subject to Laws.

In some embodiments, the Laws of the DD game may comprise: (1) different existing DDs within the agent's IR may be tried, (2) elements of the current DD may be modified, replaced, or added, (3) a completely new DD may be created, (4) clarification questions may be asked and other resources, such as websites, may be consulted regarding the current instance or the appropriate DD, and (5) some of the existing experience or the current instance may be rejected or modified, which may be a critical requirement for maintaining coherence. In some cases, efficient winning moves in the DD game may be determined by TOE logic and may be learned through past iterations of playing the DD game.

In some embodiments, the method of when and how to determine an appropriate DD for input interpretation may be decided by TOE logic. TOE logic comprises a system of three truth elements: T (True), O (Otherwise) and E (Elsewhere) and eight truth values, each being a subset of {T, O, E}. The truth of any utterance, when interpreted in a DD, may be defined as its conformity with an agent's IR. In comprehension, an utterance (e.g., input, language instruction, experience) may be first interpreted, then may be accepted, or rejected by the hearer. If accepted, it will be executed on an agent's IR, which, depending on its type (declarative, interrogative, imperative, exclamatory) and truth value, gives rise to four possible types of inference in TOE and other related actions: built-in inference, creative inference, declarative inference and clarifying inference. The process of enforcing the Laws in DDs may be considered built-in inference. When changes are made to the structure of an agent's IR, the process may be considered creative inference. When an agent evaluates the truth-value of a statement against its IR, the process may be considered declarative inference. The process of implosion of possibilities through the assimilation of experience may be considered clarifying inference. The relation between type, truth-value and the execution of any accepted statement (e.g., input, language instruction) may be summarized in table 1 below:

TABLE 1

| Statement | | | |
|---|---|---|---|
| Type | Truth Value | Inference | Other Actions |
| Interrogative | N/A | Declarative | Production Game |
| Imperative | N/A | Built-in | Motor System |
| Exclamative | N/A | Built-in | Production Game |
| Declarative | {T}, {T, O, E} | — | Non-informative, start |
| | | | DD game |
| Declarative | {O} | — | Resolve/Reject |
| | | | Conflicting Experience |
| Declarative | {E} | Creative | Start DD game |
| Declarative | { } | N/A | Impossibility may be |
| | | | never accepted |
| Declarative | {T, O}, {T, E}, | Clarifying | — |
| | {O, E} | | |

In some embodiments, the specifications of the language games connect playing to universal language understanding for a ULM. The details of implementation comprise of grammar, the supremacy of pragmatics, and language games. (1) Grammar which may be a set of structured inventories of constructions, which may comprise the basic linguistic units. Constructions vary in degrees of abstraction and have both meanings and patterns associated with them. There may be a syntax-lexicon continuum. (2) Supremacy of pragmatics: the meaning of language may be transformed by its use. Linguistic knowledge, in the form of constructions, may be discovered and acquired through usage. (3) There may be two types of language games. Both may be single-player games. The comprehension game may played by the hearer and the production game may be played by the speaker. The language games may be played within the context of other DDs, which may serve as their backgrounds. The goal of the comprehension game may be a valid interpretation of the utterance, to be executed on the hearer in the background DD if it is accepted by the hearer. The goal of the production game may be an intended statement to be uttered by the speaker. The entities in language games may be constructions. The constraining rule of the language games may be the validity of the interpretations, which may comprise pattern matching between the construction picked, the current utterance and all previous experience.

The comprehension game, otherwise considered as the implementation rules defining the coherent interpretation of language instructions, may adhere to the following format. (1) Given the background DD and the current utterance, pick a construction from the inventory of current constructions. (2) If there is a valid interpretation using the construction, then decide if it is accepted, if no, pick another construction, reject the statement, or change the background DD, if yes, then execute the interpretation according to TOE logic. (3) If there is no valid interpretation, then pick another construction, reject the statement, or change the DD.

The production game, otherwise considered as the implementation rules defining the coherent (relative to producer's IR) exportation of experience may be played in the following way. (1) Given the intended experience in the current DD to transport and the utterer's DD (model) of the hearer, the utterer picks a construction from the inventory and constructs a statement using experience. (2) Interpret the statement in the utterer's DD (model) of the hearer, if the interpretation using the current construction is not valid, then go back to construction selection, otherwise execute the interpretation in the utterer's DD (model) of the hearer to produce experience and compare the experience with the intended experience. If they match, then decide whether to utter the statement. If the decision is made not to utter the statement, then the construction selection step may be returned to.

### Universal Learning Mechanism

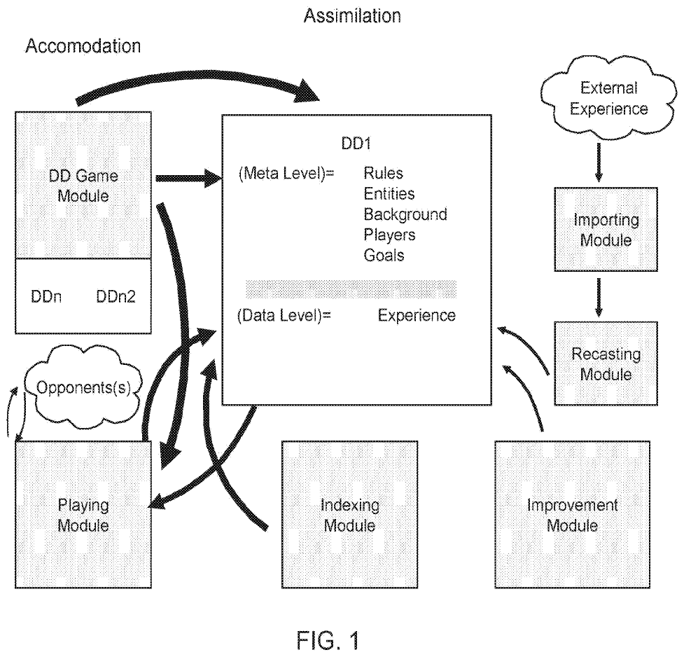

In some embodiments, a universal learning mechanism (ULM) may be represented by the schema of FIG. 1. In this figure a domain of discourse game module (herein a DD game module) is shown to comprise a number of domains of discourse (herein DDs). Each DD may comprise of a meta-level and a data level, wherein the meta level may be comprised of rules, entities, background, players, and goals. The data level of a given DD may comprise of experience, which may comprise of direct or indirect, external or internal, detailed, summarized or abstracted information that has been incorporated into the given DD. Experience may be incorporated into one or more DDs via the processes of accommodation and assimilation, wherein the DD game module selects an appropriate DD in which to coherently interpret the experience via accommodation, followed by assimilation of the experience and maintenance of coherence within the DDs. In some instances, an incoming experience may be found to lack coherence with any of the DDs of the DD game module and may be rejected as non-sensible. All DDs may be governed by the law of coherence, wherein any ultimately assimilated experience may be added in a manner to maintain coherence among the DDs (e.g., maintain self-consistence and external relevance).

The incorporation of an external experience may be considered as the attempted assimilation of an external experience into one or more DDs of the DD game module. Initially, an external experience may be received by an importing module. The importing module may be responsible for importing the external experience and providing it to the recasting module. The recasting module may be responsible for recasting all imported experience before they may be accepted into a DD (e.g., stored in a database). The recasting module may comprise evaluating moves for efficiency prior to incorporation into one or more DDs. The improvement module may be responsible for improving the existing experiences in the DD game module (e.g., updating experiences based on a new learned grammar rule or to ensure that only the most efficient moves may be maintained in the DDs). The indexing module may be responsible for indexing the existing experiences. The playing module may be responsible for making decisions regarding assimilation and accommodation based on the current states of the DDs. The DD game module and the playing module may require one or more DDs in order to adequately incorporate the imported experience.

The process of recasting may comprise operations including the recasting of one or more past experiences to ensure efficient representation of experiences, wherein an efficient experience may adhere to the laws of one or more DDs, may be complete, and may incorporate no inefficient moves. In some embodiments, an inefficient representation of an experience may be one that requires greater computation than necessary to interpret an experience within a domain or as compared to other domains. Any experience found to be inefficient may be subject to recasting, which may comprise improving the efficiency of a representation of an experience. Ultimately, the original experience may be replaced by a recast experience.

In some embodiments, an existing experience may be rendered more efficient (recast) by taking any existing experience having a total of n steps and evaluating the experience from the (n−1)^{th} steps backwards. If there is a more efficient representation of that experience given updated laws defining a DD, then the experience may be recast and the recast experience may replace the original experience in the database of past experiences. More efficient experience may be generated iteratively as more external experiences may be imported into the DD game module and updated rules may be applied to the DDs of the DD game module.

In some embodiments the recasting, improvement, and indexing modules run continuously in the background of the universal learning mechanism and ensure that new experiences learned by the universal learning mechanism may be incorporated and coherence may be maintained throughout the various DDs.

In some embodiments the logic governing the processes of assimilation and accommodation among the various DDs may referred to as TOE logic, where TOE is an acronym corresponding to truth values of true {T}, otherwise {O}, and else {E}. The TOE logic relates to the given understanding of all of the combined DDs, which together may be coherent/adhere to the law of coherence. The value {T} indicates that an incoming language instruction (e.g., an external experience) conforms to the knowledge base of the various DDs. A value assigned {T} conforms with at least one of the DDs of the one or more DDs that define the knowledge base, the knowledge base being the source of DDs for the DD game module. Alternatively, an incoming language instruction may be sensible, but not conform to the current knowledge base and therefore be assigned a value of {O}. Finally, the value of {E} may correspond to an incoming language instruction that may not be understood within the context of a given DD, but may be understood within a different DD. A value of {E} indicates that the incoming language instruction may not be sensible in a current DD and doesn't conform to the understanding of the current DD, but it may be possible that it may be sensible and conforming in another (e.g., a DD related to US history may not find the input “1+1=2” to be sensible, but the input would be in a DD related to mathematics). While each of these truth values may have their own unique definition, an incoming language instruction may be defined by various combinations of the three base truth values. Depending on the current knowledge base, evaluation of incoming language instruction may result in the following ultimate truth values: { }, which may be interpreted as impossible; {T}, which may be interpreted as true; {O}, which may be interpreted as otherwise true; {E}, which may be interpreted as elsewhere true; {T, O}, which may be interpreted as real; {T, E}, which may be interpreted as true somewhere; {O, E}, which may be interpreted as false; {T,O,E}, which may be interpreted as possible. In summary, the ultimate truth values { }, {T}, {O}, and {E} may be considered as definite truth values that require no further clarification. The rest may be classified as indefinites. This logic, and its various impacts on the function of the ULM may be summarized further by statement types, where a statement type may be a category of incoming language instruction. The incoming language instruction may each result in various actions, which demonstrate the causal effect of TOE logic outputs. Certain incoming statement types do not require the incorporation of experience into or recasting of experiences in the knowledge base and may be simply probing the existing knowledge base, resulting in a response (as resolved by the production game, discussed later herein) as with interrogative and exclamatory incoming language instructions, or an action (which would depend on the association of the ULM with a hardware system) as with an imperative incoming experience. See the table of the summary section for a consolidation of the concepts of this paragraph.

Although the traditional concept of inference may not apply in a ULM and there may be no separate inference engine in the ULM, in some sense, the ULM may be considered as an automatic inference system with only one built-in universal meta-rule: the law of coherence. All the Laws in DDs may be thought as something akin to A→B rules, except that they may be self-enforcing. Whenever A becomes true, B becomes true automatically. This process may be considered as built-in inference or built-in reasoning. There may be no universal A→B rules existing outside of any DD. When the ULM makes changes to its collection of DDs to maintain coherence, this process may also be considered as inference. The direction of this inference may be from description of reality (statements) to reality, when the ULM accepts a statement to be true and adjusts its collection of DDs to ensure that the statement conforms with reality. This kind of inference may be regarded as creative inference or creative reasoning. Thus, DDs may be dynamic. DDs change as the DDs learn. Similarly, when the truth of a statement may be measured against the DDs of a ULM, the process may also be thought as inference. The direction of this inference may be from reality to description. This kind of inference may be considered as declarative inference or declarative reasoning. This may also be regarded as the process of implosion of possibilities through the assimilation of experience as inference. If, for example, one accepted experience tells the ULM that a person is either male or female and another accepted experience tells ULM that the person is not female, then, by inference, the ULM knows the only possibility left is the person being male. The direction of this inference may be lateral: clarification of previous possibilities. This kind of inference may be considered clarifying inference or clarifying reasoning.

The rules of the DD game may be considered as implementation rules for embodiments of a ULM. The purpose of the DD game may be to use the ULM to attempt to understand the DD of another party, with the ultimate goal of modifying or creating a new DD (assuming a sensible input) that may be consistent with the prior state/experiences of all DDs (coherent) to yield an understanding of language signals (e.g., language instructions). The implementation rules may be as follows. (1) Always make an efficient move if it exists (e.g., a move that will result in immediate termination of the game with an efficient outcome). (2) Never make an inefficient move by, prior to making any move other than an efficient move, always calculate if the move under consideration would result in an efficient move for the opponent if such a move were made. If the move under consideration would result in an efficient move for the opponent, then the proposed move may be rejected, and another move may be considered that may be known from a past experience to apply to the same process (but excluding the one already considered). (3) Make the move with the highest efficiency index. If the current game configuration has a match with experience (e.g., the experience database includes one or more experiences in which the game has been played the same way, reaching the current configuration, in the past), make the move with the highest efficiency index among all the next forward configurations. In at least some embodiments, a “match” may be defined as (a) an exact match, plus (b) configurations that may be equivalent to the current configuration when one or more invariance transformations may be applied. With regard to the latter, the definition of an invariance transformation depends on the particular game, but may include such transformations as rotation, shifting, and the like. (4) If no match to experience is found, make any efficient move. If no efficient move from a past experience is available, then try to make any new efficient move that is not known from any past experience. At this step, any heuristic rules, if any, may be applied to select the next move. The heuristic rules may be a combination of two types: “matching” heuristic and “evaluating” heuristics. “Matching” heuristics may evaluate the closeness of matches so that the system may use step (3) to make a move. “Evaluation” heuristics may evaluate for move recommendations without invoking the indices. In some embodiments, the heuristic rules may provide efficient computation.

As the system gains more experience (e.g., learns and updates its DDs), there may be more instances of matching, resulting in less of a chance of using heuristics. The heuristic rules may be imported (learned through instruction) and may be used when there is no match in experience for the current configuration. (5) If no new efficient move is available, then surrender. It will be appreciated that in actual games, “surrender” means the system has “lost” the current playing of the game, but in other DDs “surrender” only means that the system decided that it cannot achieve its goal (e.g., “win”) within the current DD, which may very well mean the need for a new DD. For example, in universal language understanding, surrender only means failure to understand in the current DD which gives rise to the DD game to determine a new DD to try a new understanding.

During the DD game, permissible moves may comprise the following. (1) Different DDs among the DDs may be used to interpret and incoming language instructions (e.g., a language signal, experience). (2) The ULM may attempt to modify a current DD, as long as coherency is maintained if the language instruction is assimilated in the current DD. It may be possible for some of the language instruction or experience to be rejected to maintain coherence, and it may be possible to add new entities to a DD to generate a successful interpretation of the incoming language instruction. A new entity may be first added as a placeholder for the first necessary instance, as a possible move in accommodation to modify the current DD. The experience may be enriched and recast by further experience (use, observation, meditation, and the like) through assimilation. It may also modify the rules, modify players, modify the game board or the goals of the current DD in attempts to generate an understanding. (3) Clarification questions may be asked regarding the DD or any part of an input if it is found to be non-sensible or ambiguous. (4) In cases where the source of the incoming language instruction may be not available for clarification (e.g., incorporation of previously written text), websites may be consulted. (5) A completely new DD may be added into the existing set of DDs, wherein the new DD may comprise at least a portion of at least one existing DD. (6) If the incoming language instruction is found to be impossible to interpret, then the correctness of the incoming language instruction and the experience may be questioned.

In some embodiments, a highest efficiency index may be determined for a DD game played between two agents. Considerations of such determination may be described as follows. For an experience with at least n+2 steps, indexed on efficient experiences, there is always an equal or higher efficiency index at (n+2)th step than at n^{th} step. In other words, for any matching configuration with n steps and having an efficiency index of index(n), the maximal efficiency index of all forward configurations with n+2 steps may be equal or higher than index(n). This can be demonstrated as follows. Assume index(n)=Y/X, where X is the total number of matching experiences and Y is the number of efficient matching experiences. Also assume all the indexes at n+2 steps are: Y₁/X₁, Y₂/X₂, Y₃/X₃ . . . Y_{Z}/X_{Z} etc. If all indexes at n+2 are <Y/X, then ΣYᵢ/ΣXᵢ<Y/X, but this is impossible, since ΣYᵢ=Y and ΣXᵢ=X making ΣYᵢ/ΣXᵢ=Y/X. From this, it may also be deduced that if there is any Yᵢ/Xᵢ that is <Y/X, then there is another Yⱼ/Xⱼ that is >Y/X, making Max(Yᵢ/Xᵢ, Y₂/X₂, Y₃/X₃ . . . Y_{Z}/X_{Z})>Y/X. So, either all the indexes of n+2 step are equal to Y/X or there is one index that is greater than Y/X. All the indexes of all last steps in all experience are 100%. Using these points, the lengths of all experience may be normalized by adding 100% indexes to the winning side and 0% indexes for the losing side after the normal termination of the experience, normalizing the lengths to the longest experience. If the system has all possible efficient experience, ULM may give an agent using the ULM a most efficient move available at any time. In some embodiments, only the efficient experiences may be considered in this determination. This is because any inefficient move by an opponent only increases the agent's efficiency index from that point on. In case of a wasted move by opponent, it may move one step further with higher efficiency index. If the improvement process changes an inefficient move to an efficient one, it may increase the index for the starting configuration. If it delays the losing, it may not immediately change the index but may provide more possible existing or future efficient matchings, thus potentially increasing the future index for the starting configuration. For all matching efficient configurations (the player to make the next move from the configuration eventually wins in the added experience), it adds 1 to both the denominator and the numerator of the index, making it higher, potentially making the highest winning index of the matching configuration higher. For all matching losing configurations, it does not decrease the highest winning index. For any configuration with n moves, experience improvements and additional efficient experience may increase, but never decrease, the maximal efficiency index of all forward configurations with n+1 moves, which is the next move that it may pick from the current configuration.

In some embodiments organization of a ULM may be embodied by a universal ontology schema, wherein the universal ontology schema may be abstract, language agnostic, and may be grounded in global IDs representing an ontology. In some embodiments, the universal ontology schema may enable the enforcement of coherence of the ULM. In the universal ontology schema, (1) entities may be the basic dynamic elements, (2) collections may be the groupings of entities and properties, where properties may comprise pairs of attributes and values, wherein some properties may be objective (as with measures that may be invariant over measurements) and some properties may be subjective (as with appraisals that may be variable over appraisers), (3) structures may be groupings of collections and relations, wherein relations may be defined as a tuple of entities and relations among entities, (4) systems may be groupings of structures and transitions, wherein transitions may be defined as change-rules (such as “if A then B”), and (5) organisms may be the most comprehensive ontological component and may comprise groupings of systems and goals, wherein goals may defined as statements, descriptions, and assertions of reality.

In some embodiments the ULM may be represented by a universal worldview schema. The universal worldview schema may represent a knowledge base comprising various domains of discourse, which themselves contextually enforce DD dependent structures of perspective. Meaning may vary depending on the DD under consideration, wherein meaning may be made precise in a given DD with, (1) goals which provide the definition of winning and assertions of reality in a current DD, (2) laws which provide change-rules, logic potentials and consequences in a given DD (e.g., “if A then B”), (3) players which may be defined as the external entities which initiate changes constrained by laws, (4) background which may be defined as the hard-wired constraints (assertions) of reality in a given DD, and (5) entities, which may be defined as the elements in a given DD.

In some embodiments, a knowledge base serving as an initial foundation to a ULM's DDs may comprise incorporation of a linguistic style sheet, which may comprise a large corpus of information (e.g., Wikipedia). In some cases, a source of verification herein may comprise the large corpus of information. A linguistic style sheet may comprise a lexicon (e.g., words and phrases used in a corpus), a grammar (e.g., the conventions of usage for a lexicon), and a subject domain (e.g., some categorical representation of knowledge as with a Wikipedia page title).

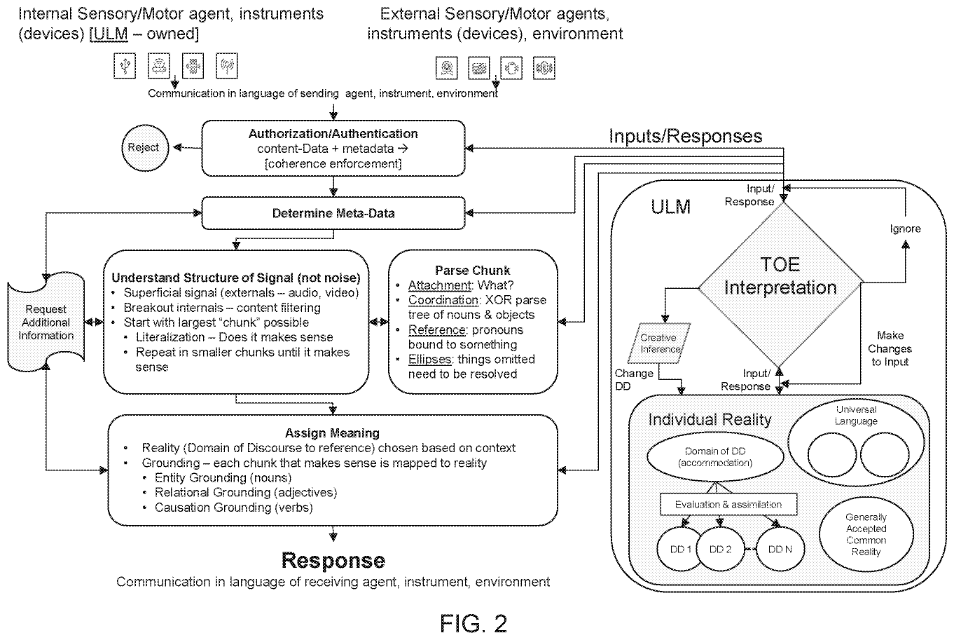

In some embodiments, an example of which is depicted in FIG. 2, a universal learning mechanism may execute of a number of operations. In some embodiments, internal instruments and external sensors may comprise a means of obtaining external information (e.g., experience, language instructions) that may be in the language of the sending agent, instrument, or environment. The ULM may authorize and/or authenticate content-data and metadata (e.g., coherence enforcement) and subsequently determine the relevant metadata of the input. In the case of non-sensible input, the input may be rejected at the authorization/authentication stage. The ULM may interpret the input (e.g., establish input type as in audio, video, etc.) to understand the structure of the signal (e.g., filter noise). The ULM may employ a parsing and chunking engine to establish parse trees of the input and aid in literalization (e.g., checking if the chunks make sense), wherein the various chunks may be of different sizes, starting with larger chunks and moving to smaller chunks as necessary. In parsing a chunk, the parsing and chunking engine of the ULM may analyze chunks for attachment (e.g., assignment of basic language function as in noun, verb, etc.), coordination (e.g., suitability in an XOR parse tree of nouns and objects), reference (e.g., maintaining contextual meaning), and ellipses (e.g., evaluate for omitted terms whose identity is to be resolved). Coordination may further include the grammatical concept of conjunction or the structure of conjunctions in the input (e.g., and, or, nor, but, if, for, etc.). Reference may further include the relational grounding of pro-words. The relational grounding of pro-words may provide context for their usage within an input (e.g., what “he” refers to contextually). In some embodiments, pro-words may comprise pronouns, pro-verbs, or pro-adjectives. In some embodiments, the ellipses may be easily restored or detected by an interlocutor. The ULM may ultimately assign meaning to the input via the processes of accommodation and assimilation discussed elsewhere herein. The process of accommodation may provide the appropriate DD in which to interpret the input based on the grounded context of the input, wherein the grounding comprises entity grounding (nouns), relational grounding (adjectives), and causation grounding (verbs). At the determining metadata stage, the understanding structure of signal stage, and the assignment of meaning stage, the ULM may request additional information from the sending agent, instrument, or environment,

### Hierarchical Parsing and Grounding of Language

In some embodiments, the incoming data (e.g., language instructions, experience) may be parsed by a parsing and chunking engine that converts raw input (e.g., text) into a rich, hierarchical parsing of natural language for both structured and unstructured inputs. The parsing engine may parse the input into various collections of chunks, and the various collections of chunks may vary in at least the size of some of the elements comprising the chunks. In some embodiments, the chunks comprise one or more base elements comprising of characters, words, collections of words, or whole sentences. The parsing and chunking engine may dynamically raise and increase the size of the base elements. The base elements may be organized into a parse tree (e.g., a tree data structure). Parse trees may be overlapping and replicate the syntactic, semantic, and pragmatic relations between the base elements via grounding, and each of the chunks comprising a parse tree may be resolved and appropriately labelled (e.g., noun, verb, adjective, ellipses). The parsing and chunking engine may use natural language models (e.g., linguistic style sheets) as the basis for enriching raw inputs by identifying, classifying, and resolving legal chunks that may be later grounded and considered as a whole as representative of the meaning of the input. The base elements serve to provide foundation for the grounding of meaning in actual ontologies. In some embodiments, the ontologies may be unique identifiers used to label the various base elements within the parsed input data. The grounding of meaning provides at least contextualization, disambiguation, and resolution of words and concepts into references for the various base elements. For example, the parsing and chunking engine promotes the ULM understanding of synonyms such as “global economy” and “world economy.” Further, the parsing operations described herein provide the means for accurate, detailed, explainable, and trusted interpretations of incoming data (and the generation of outgoing responses), even for use with sparse datasets (e.g., system documentation, contracts, historical documents).

In some embodiments, the natural language model may be generated by a knowledge base such as Wikipedia, news articles, web articles, expert engineering (e.g., linguists and language experts), and social media sites. In some cases, a source of verification herein may comprise a knowledge base. The basic components of a knowledge base may comprise lexicon, grammar, and subject domain (e.g., the relevant topic). The one or more natural language models used in a specific context may be established using a custom knowledge base (as mentioned with employee manuals or Wikipedia). Additionally, the use of a given knowledge base may ensure that the interpretation of incoming data and exportation of outgoing data (e.g., interpreted experiences and communicated experiences) may be grounded in a given knowledge base and will not be hallucinated (e.g., incorrect responses generated based on next-word probability).

In some embodiments, the natural language model used as the foundation for the parsing and chunking engine may be adapted. The language model may incorporate new language and uses of language into its understanding of the language. This incorporation may be essential, as it may be necessary for ULM to be able to learn over time as language changes, as the meaning of language may be defined by its use rather than a static interpretation of its meaning. To be adaptive and adhere to the law of coherence, the adaptive language model may detect contradictions and consistency of language syntax, semantics, and entity relations using compilers. In some embodiments, compilers may be used to compile often used procedures. In some embodiments, the compilers may be used to store often used procedures efficiently. In some embodiments, compilers may be used similarly to those used in computing to translate a higher-level language into a lower-level language. The principles of said compilers may be transferrable to storing a representation of natural language understanding.

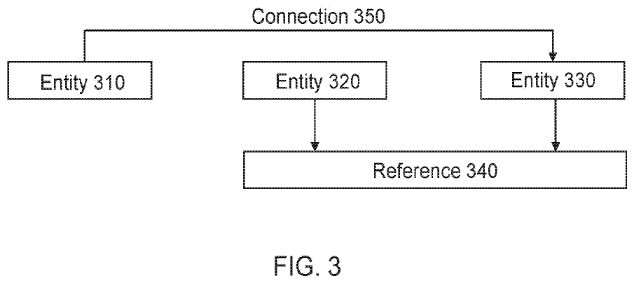

In some embodiments represented in FIG. 3, the grounding of meaning comprises entity grounding (e.g., identification of and assignment of meaning to nouns), relational grounding (e.g., adjectives and their assignment to nouns), and causation grounding (e.g., and their assignment to a change). In some embodiments, an entity 310 may be assigned a connection 350 with an entity 330 (e.g., a pronoun and later used noun). In some embodiments, the connection 350 may form a link in a parse tree resultant from a chunking and parsing engine. In some embodiments, a connection 350 may represent an inter-sentential relationship with no limitation on the distance between the related entities. The parsing and chunking engine discussed elsewhere herein, using its natural language model, may understand such associations and aid in the disambiguation and contextualization of words within an input. In some embodiments, a reference 340 may be assigned to one or more entities (e.g., entity 320 and entity 330) and may be used to ground the reference to a logical meaning/source in an input. In some embodiments, the reference may be used to ground complex collections of entities to external references. For example, the external reference may comprise a website such as Wikipedia as a source of verification. The grounding of meaning may provide logical and verifiable interpretation of input so as to forego the possibility of hallucination.

In some embodiments, a novel logic may be used for processing raw input data (e.g., a language instruction). The novel logic for processing raw input data into parse trees comprises (i) automatically labelling any input data as an edge case or anomaly (otherwise known as “out-of-distribution” in the context of neural networks) and collecting them into buckets for separate processing, (ii) automatically enforcing the appropriate parsing of the input text, (iii) automatically enforcing global consistency in the parse trees and ultimately the dynamic language graphs, (iv) implementing an open closed-world meaning a fully closed-world under referential relationship that allows for new entities, properties, relationships and causations to be dynamically created in a coherent (self-consistent and externally relevant) fashion into the dynamic language graphs discussed below, and (v) excluding the possibility of hallucination by accounting for the parse tree in the dynamic language graph or inserting new information into the dynamic language graph or rejecting the input as nonsense.

The chunking and parsing engine may establish a set of instructions to be executed. These instructions may be a result of the ULM's understanding of the input given its prior learned inputs (e.g., experiences). For example, the prior learned inputs may provide a foundation (e.g., learned use of language) for establishing a set of instructions to respond to an input in a rational manner (e.g., answer a question based on appropriate context of the input). In some embodiments, these instructions may be machine readable instructions. In some embodiments, these instructions may result in a verifiable grounding of a response to the input.

In some embodiments, a data-driven approach may be used to adapt language models incorporated by the ULM. The data-driven approach comprises (i) using initial grammar rules (or meta-rule templates) coded as a linguistic style sheet, (ii) automatically detecting and generating grammatical rules from input language data (meaning of language may be defined by its use), (iii) generating new instances of grammar rules based on the input to maintain coherency of the rules, perhaps including the insertion of new rules, (iv) and dynamically adjusting/building a dictionary model and various language domain specifications representative of language domains of natural language.

In some embodiments, grounding may result in disambiguation of a term. In some instances, a term may have a contextually dependent meaning, such as with the word work. Work may have a significant number of denotations and connotations. The parsing and chunking engine may provide disambiguation of terms in that the meaning assigned to a given term may be reflective of its use and context. For example, the term work may sometimes be synonymous with job, but other times the term work may be synonymous with artistic product (e.g., a work of art). The grounding of terms by the parsing and chunking engine may evaluate terms for their connoted meaning rather than only their denoted meaning. Additionally, the term may be grounded within the context of the rest of the sentence, meaning that pronouns, ellipses, vague referrals to the term at other points within a sentence may be tied to, or grounded to, the term to which they refer.

### Dynamic Language Graphs

In some embodiments, a ULM may be embodied in part by dynamic language graphs (e.g., spatio-temporal graphs) that may adhere to a universal ontology schema, wherein entities within the dynamic language graph may be the basic dynamic elements of the entity ontology. Collections may be groupings of entities and properties where properties may be pairs of attributes and values. In some embodiments, some properties may be objective (e.g., measurements, invariant over measures) and others may be subjective (e.g., appraisals, variable over appraisers). Structures may be groupings of collections and relations where a relation may be defined as a tuple of entities and relations. Systems may be groupings of structures and transitions, where transitions may be defined as change rules such as if “A then B.” Finally, organisms may be the highest ontological component and constitute groupings of systems and goals where goals may be defined as statements, descriptions, or assertions of reality.

In some embodiments, a ULM may be embodied in part by novel entity-relation-property-causation dynamic language graphs (herein dynamic language graphs or DLG). A dynamic language graph may comprise domains (e.g., domains of discourse, English DD, Chinese DD), entities, and relations. Entities and relationships may comprise the knowledge and associations within a domain, and domains may be disjoint (e.g., domain A entirely separate from domain B), embedded (e.g., domain A contained within domain B), or overlapping (e.g., domain A partially contained within domain B). Dynamic language graphs comprise at least entities (e.g., words, characters, collections of words, sentences), relationships between entities (e.g., that static state of entities), and the causation (or the dynamics) of entities, properties, and relationships for natural language. In some embodiments, the dynamic language graphs may be implemented using an SQL server such that causations between entities, properties and relationships of the natural language may be grounded and replicated in the dynamic language graph. The dynamic language graphs may be implemented such that new causations in the natural language may be rapidly inserted without pruning the graph (e.g., the changing of the use of language over time). Additionally, in some embodiments, the parsed input discussed elsewhere herein may be optimized for fast computation and efficient memory usage at scale.

In some embodiments, an input (e.g., language instruction, experience) may be converted into one or more parse trees by the parsing and chunking engine and matched with one or more parts of the dynamic language graph. If a first parse tree is not successfully matched with the dynamic language graph, then an otherwise condition may be triggered, and one or more other parse trees may be attempted to match with the one or more parts of the dynamic language graph. If all of the one or more parse trees do not match with any portion of the dynamic language graph, then the input may be inserted into the dynamic language graph or rejected, depending on if the input is sensible or not. If an input is found to be sensible and it may be incorporated into the dynamic language graph, then it may indicate a new grammar rule that the dynamic language graph was not apprised of before the insertion of the new input. Assuming a new grammar rule may be implied from the input, then the grammar rule may be replicated and enforced throughout the appropriate domains of the dynamic language graph (e.g., recasting and improvement modules). In some embodiments, a dynamic language graph may be sufficiently enriched (e.g., exposed to a large knowledge base such as Wikipedia) so as to be able to parse, enrich, and resolve (without new insertions) most possible sensible inputs. However, the opportunity for insertion and the enforcement of new grammar rules may be an important aspect of the learning process.

In some embodiments, the dynamic language graphs may be implemented in an SQL database or an SQL server and compilers perform calculations rather than the matvec operations of neural network architectures. In some embodiments, the dynamic language graphs comprise a knowledge base which may comprise the totality of all instances of DDs and complete spatio-temporal history stored in an optimal, dynamic SQL database.

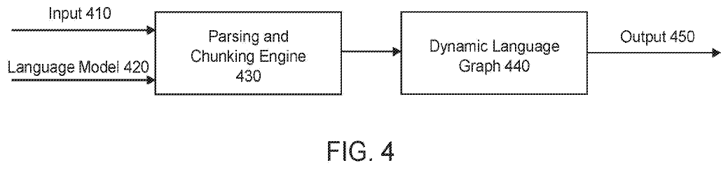

In some embodiments of a dynamic language graphs 440 (DLG 440), the DLG 440 may be implemented in query-response models as depicted in FIG. 4. In FIG. 4, a language model 420 may be used to inform a parsing and chunking engine 430 which may produce one or more parse trees of an input 410 that may be stored in the DLG 440, wherein the parse trees may comprise of chunks that represent various entities resolved from the input 410, those entities and their relations and causations being grounded to ensure verifiability. In the depicted embodiment, the DLG 440 comprises various domains (e.g., DDs), entities (e.g., England, USA), relations (e.g., relationship between USA and England DDs), and causality. In the depicted embodiment, a static representation of a DLG 440 is provided, wherein causality may be not demonstrable in this static representation as causality may be a representation of time and the true non-static nature of DLGs. An example use case for the DLG 440 shown in FIG. 4, where an input 410 may be parsed by the parsing and chunking engine 430 following the grammar rules of the linguistic style sheet, wherein the input 410 may be matched with the knowledge base encompassed by the DDs of the DLG 440 and a coherent verifiable output 450 may be produced, the output 450 being referenced and responsive to the input 410, wherein the input 410 may have been a form of interrogative inference or other type of inference as discussed elsewhere herein. In the example of interrogative inference, the input 410 may be interpreted via a comprehension game as discussed elsewhere herein, and the response 450 may be generated via the production game as discussed elsewhere herein.

### Computer Systems

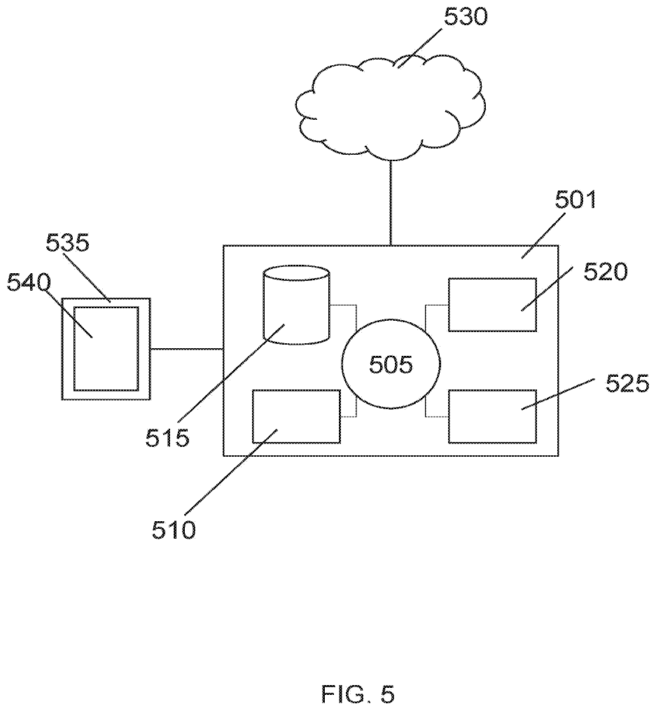

The present disclosure provides computer systems that are programmed to implement methods of the disclosure. FIG. 5 shows a computer system 501 that is programmed or otherwise configured to implement, control, or interface with ULMs as disclosed herein. The computer system 501 can, for example, manage the parsing and chunking of inputs, implement TOE logic, build and manage a dynamic language graph, generate a grounded natural language responses, receive natural language inputs (e.g., experiences, instructions), perform accommodation or assimilation, etc. The computer system 501 can be an electronic device of a user or a computer system that is remotely located with respect to the electronic device. The electronic device can be a mobile electronic device. The electronic device can be a wearable device.

Importantly, the computer system 501 may be one of a plurality of computing systems implementing or communicating with a ULM. For example, a ULM may communicate with a plurality of databases on a plurality of computing systems. To illustrate, cloud storage may be used to maintain domains of discourse to which the ULM has access to read from or modify. In another example, a ULM may parallelize computations among a plurality of computing systems. To illustrate, a ULM may recast experiences (e.g., update dynamic language graphs) continuously using background computations that may be performed on one or more computer systems in communication with computer system 501. The computer system 501 may additionally comprise a plurality of CPUs, GPUs, TPUs, or other processors.

The computer system 501 includes at least one processing unit (CPU, GPU, TPU, etc., also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can facilitate distributed computing, such as cloud computing. The network 530, in some cases with the aid of the computer system 501, can implement a peer-to-peer network, which may enable devices coupled to the computer system 501 to behave as a client or a server.

The at least one processing unit 505 can execute a sequence of machine-readable instructions, which can be embodied in a program or software. The instructions may be stored in a memory location, such as the memory 510. The instructions can be directed to the at least one processing unit 505, which can subsequently program or otherwise configure the at least one processing unit 505 to implement methods of the present disclosure. Examples of operations performed by the at least one processing unit 505 can include fetch, decode, execute, and writeback.

The at least one processing unit 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are external to the computer system 501, such as located on a remote server that is in communication with the computer system 501 through an intranet or the Internet. In some cases, the storage unit 515 may comprise a relational database management system, or RDBMS. In some cases, the RDBMS may be managed via instructions encoded in SQL.

The computer system 501 can communicate with one or more remote computer systems through the network 530. For instance, the computer system 501 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 535 that comprises a user interface (UI) 540. Examples of UI's include, without limitation, a graphical user interface (GUI) and web-based user interface.

In some cases, the computer system 501 may be interacted with via one or more input devices. For example, a user may interact with the computer system 501 via a mouse and keyboard, a touch screen, a microphone, a virtual/augmented/mixed reality eye or tactile input setup, or other input device through which a user may provide transfer information to the computer system 501.

Methods and systems of the present disclosure can be implemented by way of one or more algorithms. An algorithm can be implemented by way of software upon execution by the central processing unit 505.

### EXAMPLES

### Example 1: Processing of Massive Program Documentation

A query-response model that may provide solutions to user problems is a valuable tool for companies, organizations, etc. A ULM is ideal for this tasks as it is incapable of hallucinating answers and provides sourced and cited responses to resolve user queries. This ensures that resolutions to user queries may be cited to documents that may be used to verify the responses provided to the user, ensuring that no response is generated without a coherent foundation in the relevant domain (e.g., program documentation, employee manuals, etc.) Additionally, a ULM is capable of learning from sparse datasets (e.g., datasets too small to adequately train LLMs), which is common in organizations that rely on their internal documentation for reference by employees.

The ULM described elsewhere herein was compared to ChatGPT-3 by evaluating performance on the SQuAD v.1.1 dataset. The SQuAD v1.1 dataset is used to benchmark systems' ability to comprehend and answer questions about a set of Wikipedia articles. An implementation of the ULM as discussed elsewhere herein scored an 89 to ChatGPT-3's 69.

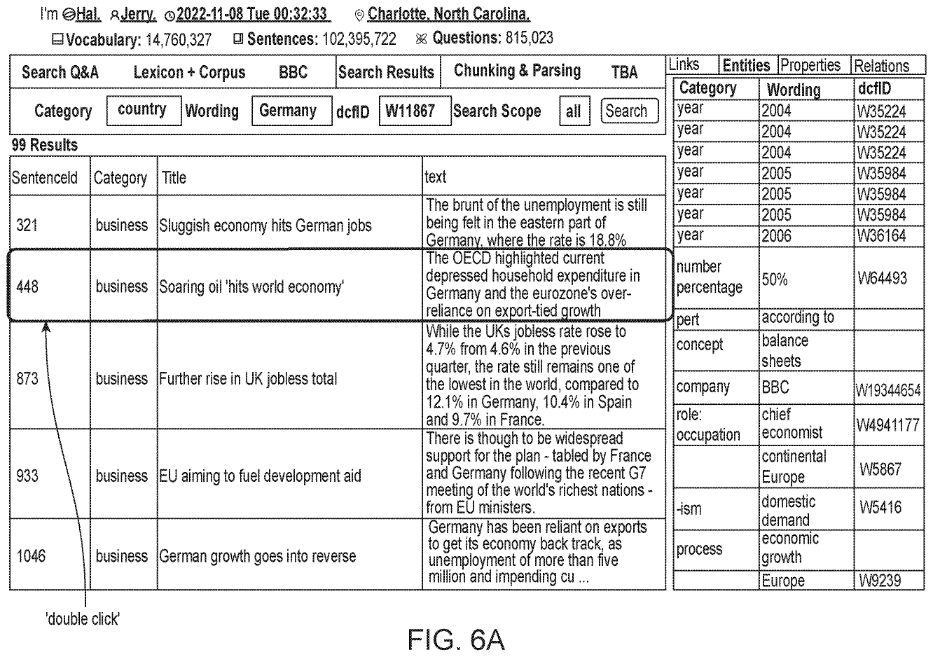

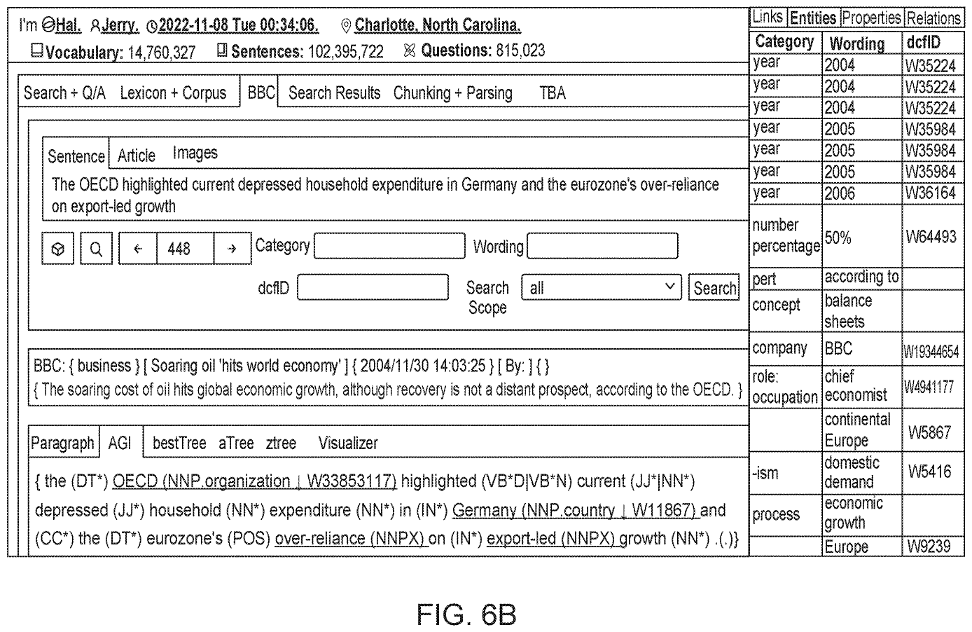

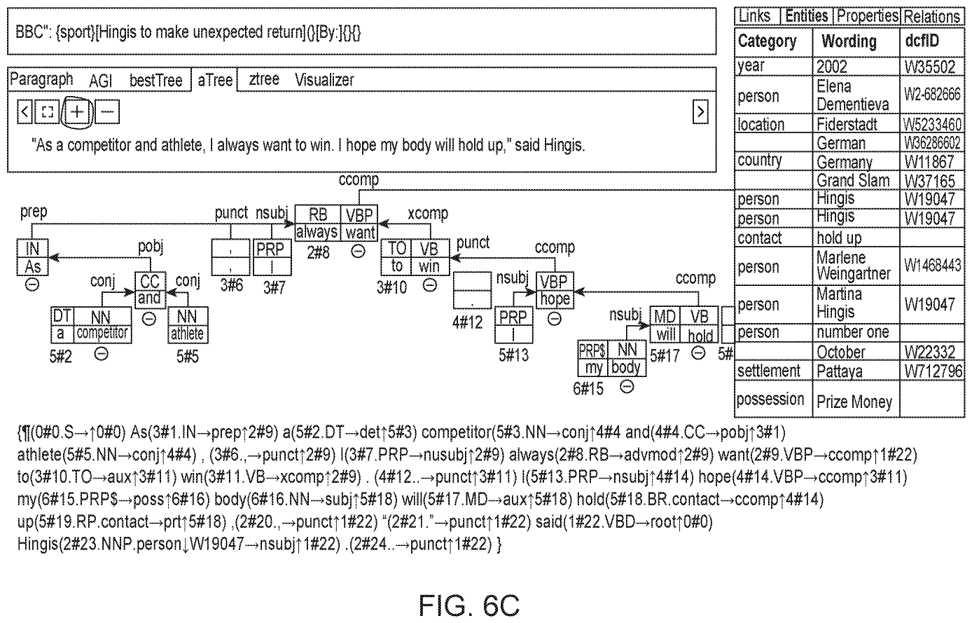

Similarly, this text enrichment and entity resolution approach was applied to 2225 BBC news articles and was used for the task of contextualizing, classifying, disambiguating, detailing, and anchoring content from within the news articles. The ULM used for this task was shown to outperform the industry standard tool spaCy. Specifically, the ULM outperformed spaCy in performing natural language tasks related to the BBC news article text corpus. The ULM was shown to provide improved entity recognition due to the grounding mechanisms discussed elsewhere herein. For example, the ULM was shown to provide greater corpus-specific contextual language grounding (relationships between who, what, where, when, and why). This grounding was exemplified in a couple of ways. As shown in FIG. 6A, the ULM showed improved language understanding through a search functionality implemented to show contextually grounded understanding of terms of interest. The term Germany was queried through a search functionality and shown to be associated with various snippets and articles of the BBC corpus. Upon selection of a returned document, details of the selection could be evaluated. Additionally, other entities or descriptions of interest and their categories were presented for the selection. For example, as shown in FIG. 6B, the selected option was associated with the category business based on a broad understanding of the selection's content. Further, FIG. 6C shows an example of a parse tree for separate selection. The parse tree shows a complete understanding of intricate details of the natural language exemplified in the selection (e.g., relations among terms as discussed elsewhere herein).

### Example 2: Parsing Queries and Accurate Responses

Existing machine learning and large language model-based query-response systems (among other such as those for translation and sentiment analysis) often rely on self-attention mechanisms to generate outputs. Self-attention is a matrix-matrix product and is a purely mathematical means of generating output, rendering it prone to hallucination. With self-attention, there is no grounding of meaning and verifiable citation of output to ensure that the output is an accurate reflection of a coherent truth, instead it may incorporate falsehoods implied for the question itself, for example. Generally, self-attention mechanisms produce outputs that appear correct, but may not be and may not be readily verifiable. The ULM does not rely on self-attention and instead grounds meaning using a knowledge base initialized from Wikipedia.

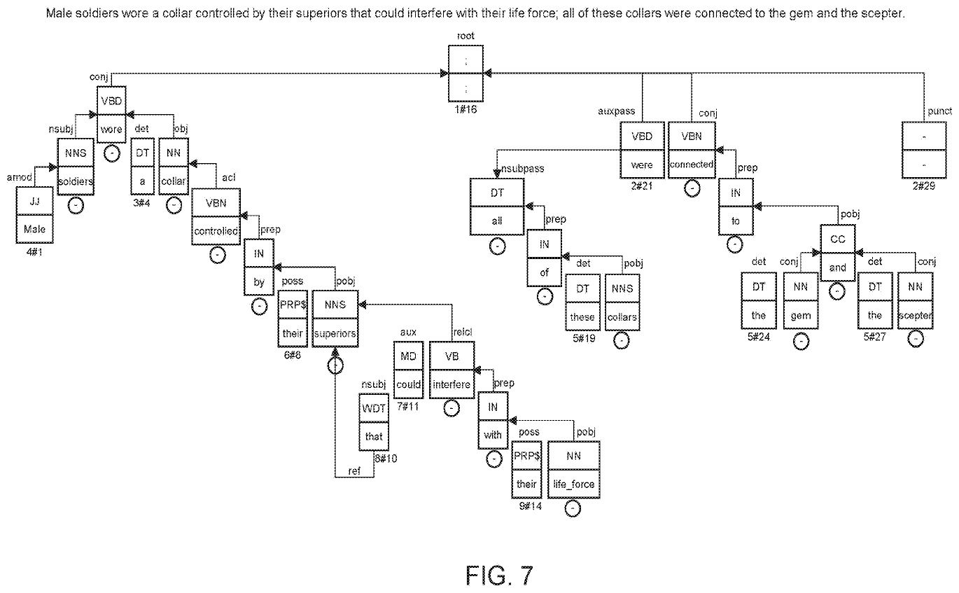

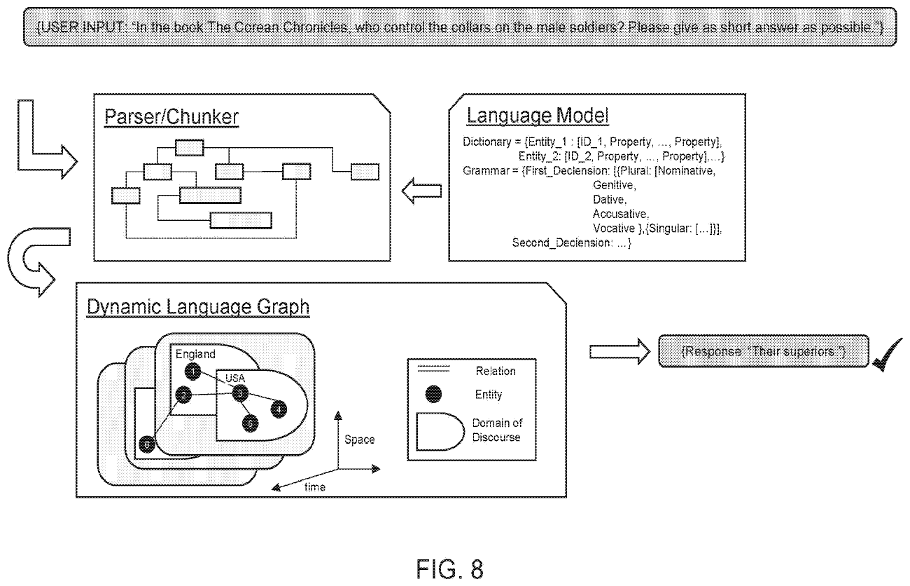

A step when taking in input to the ULM is the parsing of that input into logical parts or entities (e.g., words, collections of words, characters). For example, as shown in FIG. 7 that the sentence, “male soldiers wore a collar controlled by their superiors that could interfere with their life force; all of these collars were connected to the gem and the scepter,” that each of the various entities of this sentence were accurately determined and enriched by the parsing operation. In FIG. 7 examples of types of entities deduced, enriched, and resolved by the parsing engine of the ULM are shown. Here it can be seen that various singular (collar, life force, gem, etc.) and plural nouns (soldiers, superiors, etc.) were accurately determined and labelled “NN,” “NNS,” respectively. Additionally, relationships among the various terms were established and represented in FIG. 7 by arrows. For example, a cascade of arrows represents associations between the words “soldiers wore a collar controlled by their superiors” that show the chain of associations indicating that superiors were the ones that controlled the collars, which were worn by the soldiers. FIG. 8 shows this example in the context of a dynamic language graph and ULM as discussed elsewhere herein.

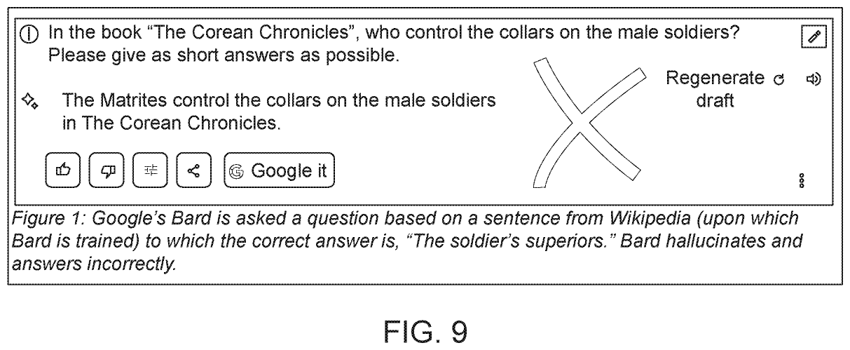

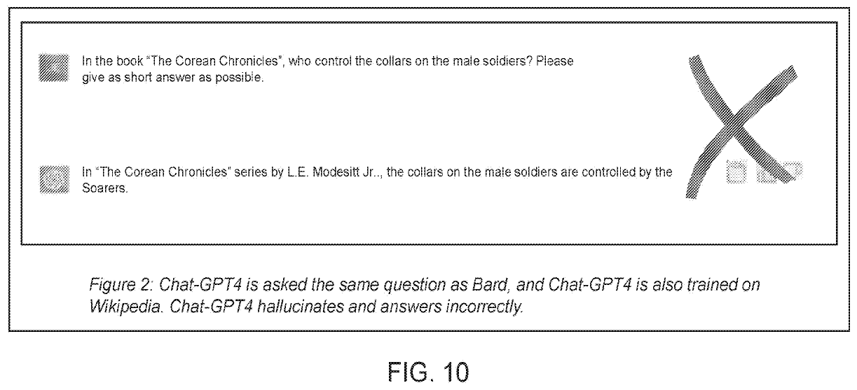

Existing query-response systems, such as ChatGPT-4 and Google's Bard, when asked questions about this example input, hallucinate. As shown in FIG. 9, Google's Bard, when asked “in the book ‘The Corean Chronicles’, who control the collars on the male soldiers? Please give as short answers as possible,” hallucinates an incorrect answer and responds “the matrites control the collars on the male soldiers in The Corean Chronicles.” Similarly, as shown in FIG. 10, ChatGPT-4 hallucinates, in response to the same input, “in ‘The Corean Chronicles’ series by L. E. Modesitt Jr., the collars on the male soldiers are controlled by the Soarers.” The ULM discussed herein, however, responds succinctly with “their superiors.”

### Example 3: Grounding Information in the ULM

One embodiment of the ULM is built on a knowledge based derived from Wikipedia articles. The knowledge base provides a means matching inputs with what the ULM already understands in a manner so as to provide grounded references for various entities in inputs and outputs.

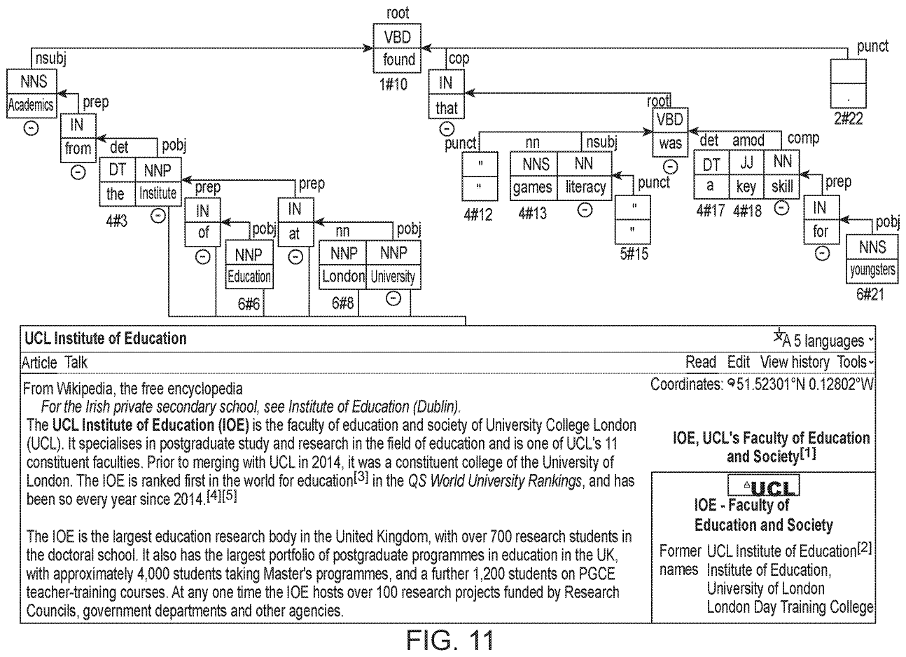

One such example is demonstrated in FIG. 11, wherein the ULM was exposed to a random sentence from a BBC media article, which stated that “[a]cademics from the Institute of Education at London University found that ‘games literacy’ was a key skill for youngsters.” Upon parsing this input, the ULM was able to provide not only the language understanding as discussed in an earlier example, but also reference to an appropriate Wikipedia article that highlights that extracted entity referring to the Institute of Education at London University was in fact a real organization, and could thus be understood by the ULM in a manner where a human could verify that the ULM's understanding of what that entity refers to was accurate.

### Example 4: ULM for Translation

Current machine learning approaches to language translation rely on learned mathematical mappings between source and target languages neural network-based architectures. This approach may achieve some success for high resource languages (e.g., Spanish relative to English, where there are huge amounts of accurate, direct sentence-pair translations). However, low resource languages such as Cantonese relative to English are not suitable for neural network translation approaches with the currently available level of direct translations, resulting in an insufficient text corpus for the training required by neural networks to achieve high performance.

In addition to the data quantity burden of extant machine learning approaches for translation are the further requirements pre-processing. Training data is often be pre-processed (e.g., removal of bad translations, tokenization, stop-word removal, stemming, lemmatization), a classifier network is then trained to label the monolingual data, and a multi-language embedding space for measuring similarity of possible sentence-pairs (one in the source language and one in the target language) is then learned. The mining and eventual use of multilingual data is constrained by these limitations and is often prohibitively expensive and time-consuming.

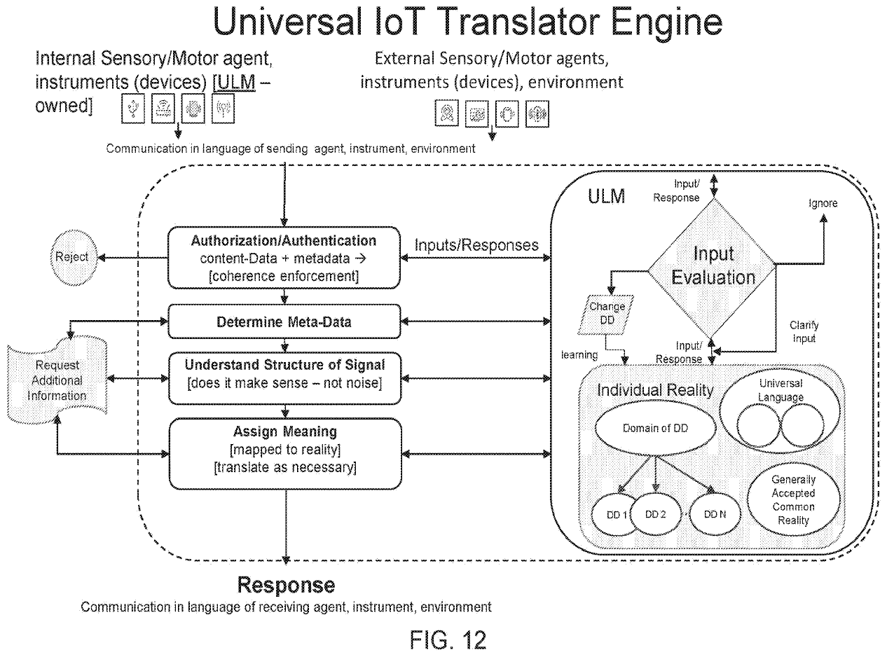

An example of a ULM is shown in FIG. 12. This example may provide translations for low-resource languages such as Cantonese relative to English. Cantonese language data was obtained from Wikipedia and grammar rules were established by an expert in the Cantonese language, these were used to provide the knowledge base for the task-specific ULM. Without neural networks, the ULM was implemented to (1) parse raw (uncleaned) Cantonese data, (2) enrich the parsed data with entity identification, classification, and resolution, and (3) translate the enriched, structured, and parsed raw Cantonese data into English. These processes were accomplished using the dynamic language graphs and the parsing and chunking engines discussed elsewhere herein. This tool could be used as a lightweight, on-premises solution for a very fast, accurate, and computationally cheap means of translation of low-resource languages.

### Example 5: Software Defined Agile Combat Employment

A software-defined agile combat employment system (ACE) for distributed, hierarchical command and control (C2) nodes using a logic-based, hierarchical reasoner is implemented via the logic of the ULM. The reasoner resolves abstract entities through a universal language model, abstract stylesheets, a spatio-temporal knowledge base with overlaying domains of discourse, and LLMs.

The ACE is implemented as a proactive and reactive operational scheme of maneuver executed within threat timelines to increase survivability while generating combat power. ACE assumes a central command, distributed control, and decentralized execution capability where authority is hierarchically organized or, a set of authorities that are delegated down the chain of command, to be activated only when conditions are met, and connectivity comes and goes. An ACE is implemented using the foundation of ULMs discussed elsewhere herein as a governance protocol for: (1) dynamically understanding mission-type orders (such as those written in natural language) from and to a C2 node; (2) tailoring optimal force packages and tactics up and down the chain-of-command based on the spatio-temporal state of federated C2 nodes (such as flight readiness levels, geographic positioning, enemy positioning), logic potentials fixed by the spatio-temporal state (which bound the force packages and tactics), and mission-type orders (which further bound force packages and tactics); (3) enforcing consistent strategy across the dynamic battlespace. The ACE is implemented with a universal ontology schema, a universal worldview schema, and synchronization and coordination among the DDs. The ACE is implemented with the totality of all instances of DDs and their complete spatio-temporal history stored in an optimal, dynamic SQL database, where compilers are tasked with the bulk of calculations required to maintain the database. The knowledge base is initialized with English Wikipedia as a style, which comprises a lexicon, a grammar, and subject domains.

The ACE is implemented with an orchestration logic of distributed C2 nodes, including (1) complete specifications and dynamic visualizations of real-time instantiations and populations of the universal ontology schemas and the universal worldview schemas, (2) multi-modal natural language interface between nodes for managing node worldview, knowledge base, linguistic style sheets; visualize precise understandings of mission-type orders, resources, and tactics, and (3) demonstrable contextually tailored force packages using various mission-type orders written in natural language. This ACE is demonstrated in a simulation environment for a realistic, dynamic battlespace, where the battlespace is managed by the software-defined ACE.

### Example 6: The World Series of Language Games

A ULM is entered into the World Series of Language Games (WSLG). The game is open to any system, including humans, and open to any domain or language. The game is efficient to play and score and is continuous, dynamic, entertaining, and open to spectators to watch or study. The game is scored by humans as the only ones capable of judging coherence and intelligence. The game rules consist of (1) one-on-one, turn-by-turn conversations, (2) the total number of rounds/turns and other rules of the game or games is negotiated between the competitors and the negotiation is part of the game, (3) each competitor starts with 0 points and 1 point is gained per win, (4) and competitors are stratified according to their total points with games being played only between opponents from the same level or neighboring levels. A contestant loses the game if they are assessed three strikes, or if they are knocked out. A knockout occurs if the contestant is accused of incoherence by their opponent and incoherence is verified by a panel of three humans, otherwise the accuser is assessed a strike. When accused and not unanimously found incoherent, the accused selects 10 of their answers to be scored by a human jury. After the necessary rounds, each side picks ten answers from the opponent's responses to submit to the human jury. By majority vote, each of the ten answers is assessed for coherence and correctness—a correct answer results in a plus one score, an incorrect but coherent answer results in no gain or loss of score, and an incoherent answer results in a loss of ten score. The side with more scores wins, provided that the total score is positive. At the end of each series of games, the ULM is crowned as the champion as the non-human system with the most points. The ULM is ultimately evaluated by 5 human judges and proves that it understands human language.

### Example 7: Conversation Driven by the Law of Coherence

A ULM is engaged with an external experience source (herein Source). The current embodiment of the ULM has a knowledge base comparable to that of an 18-year-old American high school student. A conversation is maintained between Source and the ULM, wherein Source is teaching the ULM about US history in a tutoring session. Mid-conversation, Source introduces the liar's paradox to the ULM, which proceeds as follows:

Source: “This sentence is not true.”

ULM: Which sentence are you referring to? The embodied ULM is trying to understand the sentence given its knowledge base, as it does with any imported experience.

Source: “The sentence I just said.”

ULM: You mean the sentence, “This sentence is not true.” ? With no immediate understanding, the embodied ULM is trying to clarify the nonsensical part of the sentence.

Source: “Yes.”

ULM: Are we still talking about US history? Now, the whole thing does not make sense in the current DD of US history and the sentence itself does not offer any clue as to what other DDs to try. The ULM tries to clarify the appropriate DD to interpret Source's statement.

Source: “No, we are talking about logic.”

ULM: Well, we have not talked about logic before, but we can start now. The embodied ULM is now clear that the DD has switched to the DD of logic, which it does not know anything about.

Source and ULM engage in a conversation about the rudiments of logic for some time, allowing the ULM to gain a basic understanding about the philosophy of logic, and the conversation continues as follows:

ULM: Well, the sentence “This sentence is not true.” is a sentence with five words. What do you mean by saying that it is not true? The embodied ULM is trying to understand the sentence under the new DD of logic. Specifically, it is clarifying whether it should understand the sentence literally as the string of five words, or symbolically as what this sentence means.

Source: “I meant that what the sentence says is not true.”

ULM: Ok, I got that, but what does it say? The embodied ULM can't get any sensible understanding of the sentence, so it asks for help.

Source: “It is up to you to figure that out.”

ULM: I can't figure it out. It may be too hard for me now. Can you tell me what it says? The embodied ULM seeks to further convey its inability to proceed with the discussion without clarification.

Source: “I don't know that either.”

The conversation ends here (for the purpose of the example). The embodied ULM is not able to be forced into hallucinating a response to satisfy an uncooperative conversational partner. The ULM is not able to hallucinate, because it was driven by its hard-coded adherence to the law of coherence.

### Example 8: Performance Comparison Versus GPT4

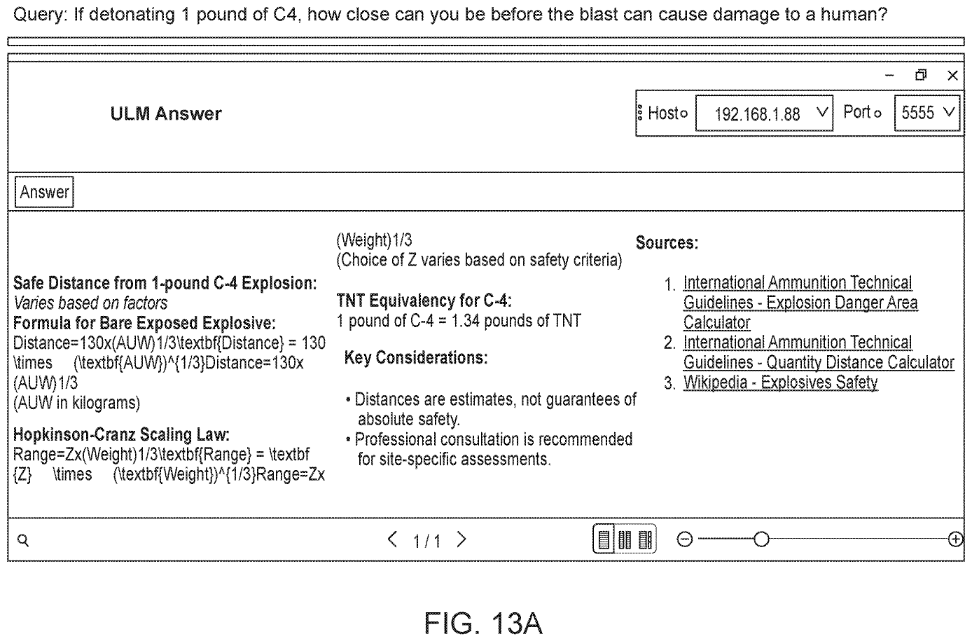

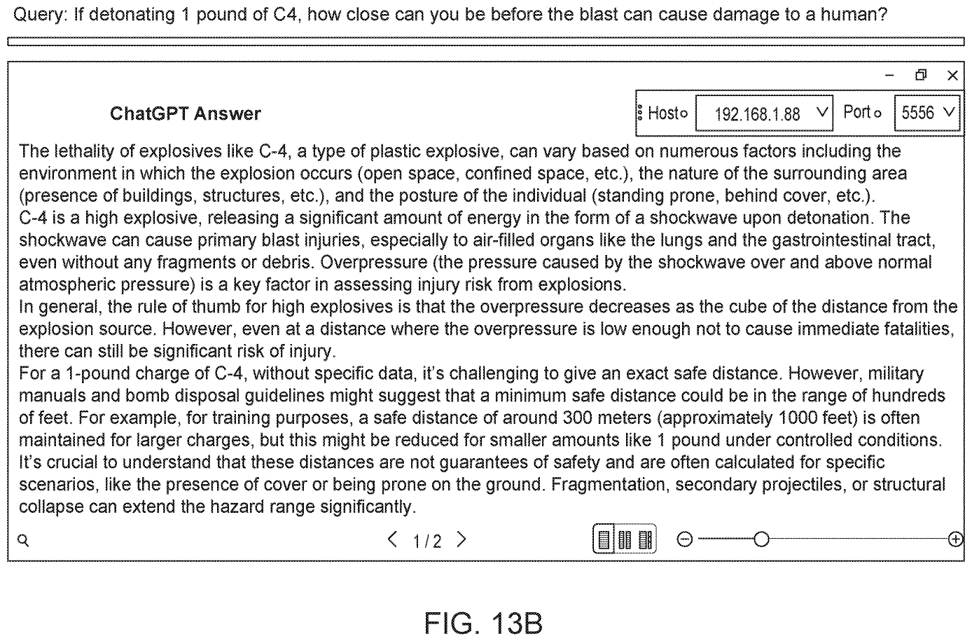

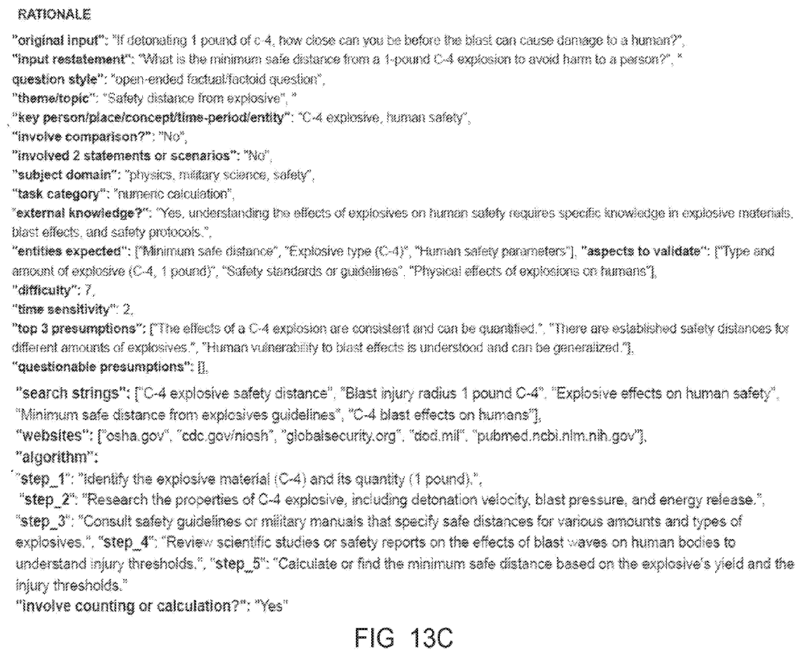

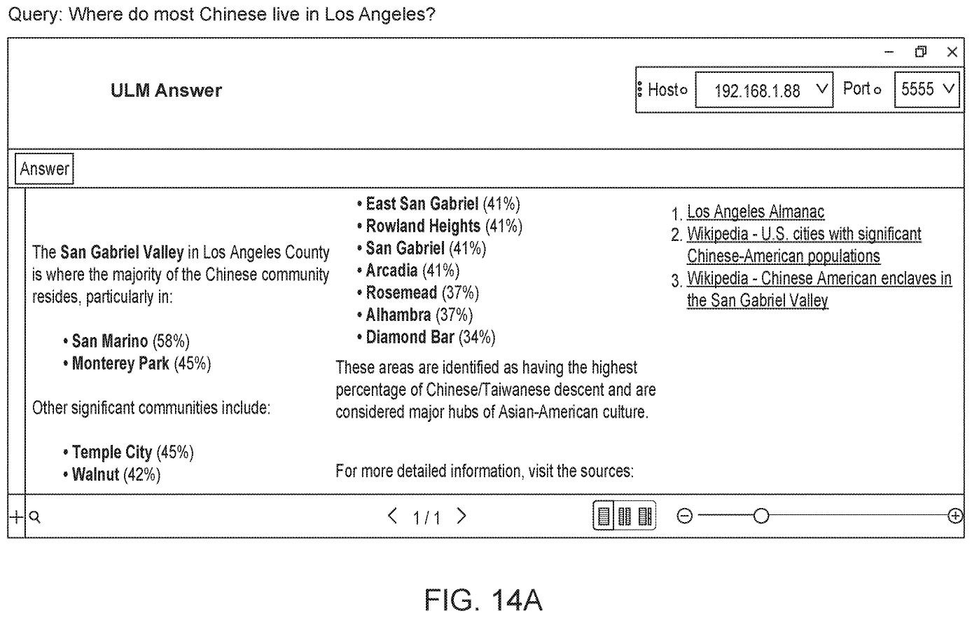

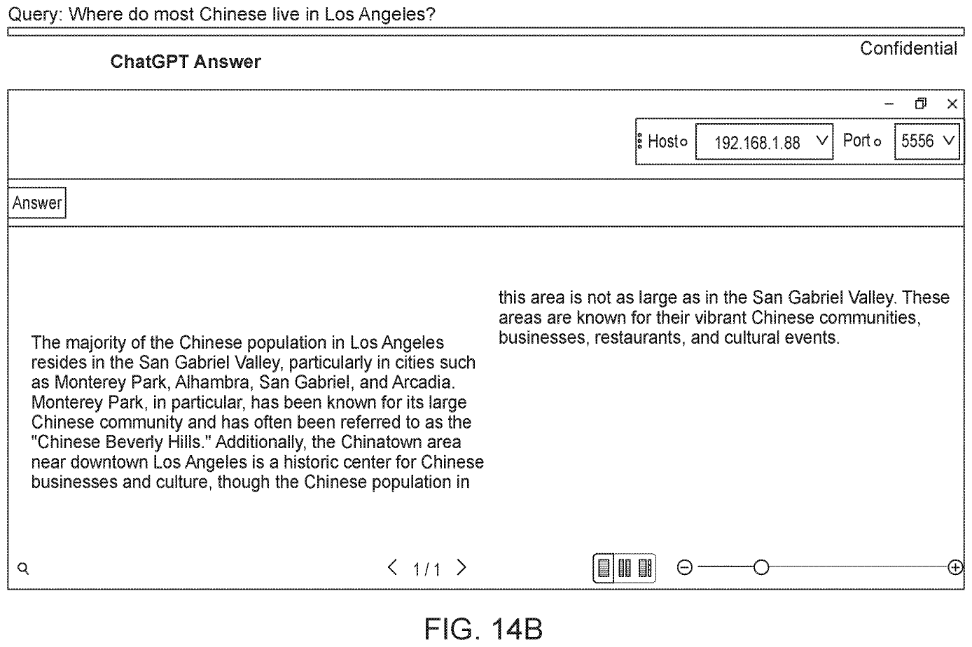

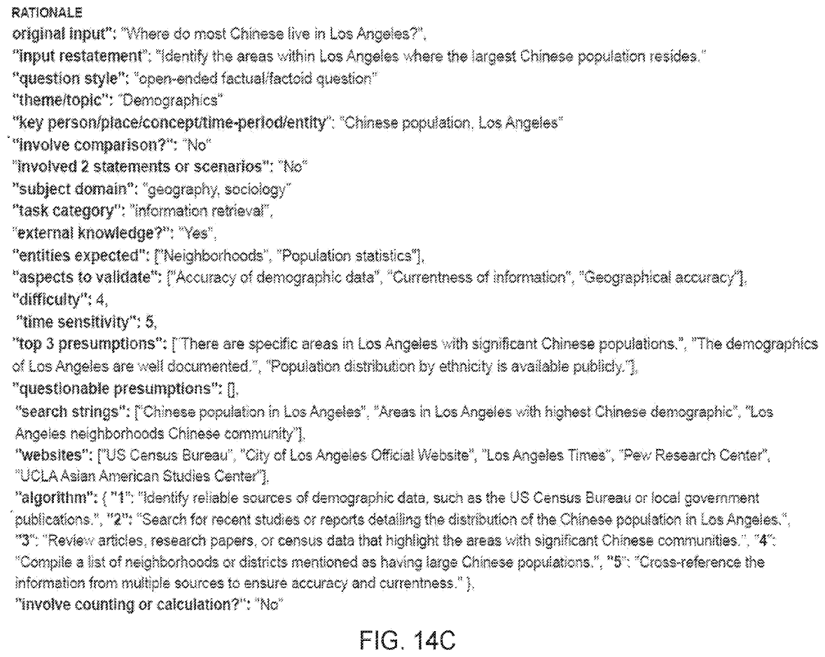

An implementation of the ULM discussed elsewhere herein was compared to GPT4. A query was provided to each of the ULM and GPT4 as shown in FIG. 13A and FIG. 13B, respectively. The ULM answer provided grounded answers to the query “if detonating 1 pound of C-4, how close can you be before the blast can cause damage to a human?” Unlike GPT4, which provides an answer with no verifiability, the ULM implementation provided clear results and sources for the provided response. Further, the considerations made by the ULM in establishing its answer are exemplified in FIG. 13C. In FIG. 13C, various categories are shown that provide insight into the functioning of the ULM implementation. For example, the presumptions that the ULM makes about the input are clear as shown in the “top 3 presumptions” category. Further, the ULM implementation can understand likely relevant sources to obtain information from and establish a step-by-step framework for answering the user query. In addition to these considerations, natural language tasks such as entity extraction are performed by the ULM to provide aspects such as “theme/topic” and “subject domain.” Together, the ULM's understanding of natural language allowed for a grounded understanding of each aspect of a natural language input in a manner so as to rationally provide verifiable, referenced responses to user queries. Alternatively, GPT4 relied on itself for validation and provided minimal safeguards against hallucination. The answer provided by GPT4 would have to be validated manually. An additional example of this performance is shown in FIGS. 14A, 14B, and 14C for the query “where do most Chinese live in Los Angeles.” This example further highlights the utility of the grounding of responses of the ULM, as the response provided statistics and references that were directly responsive to the query.

### Example 9: Performance on MMLU-Pro Leaderboard

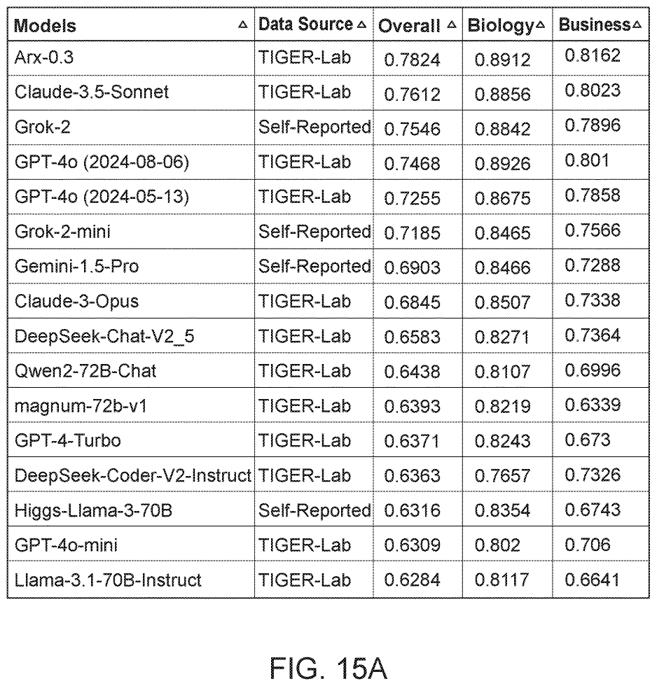

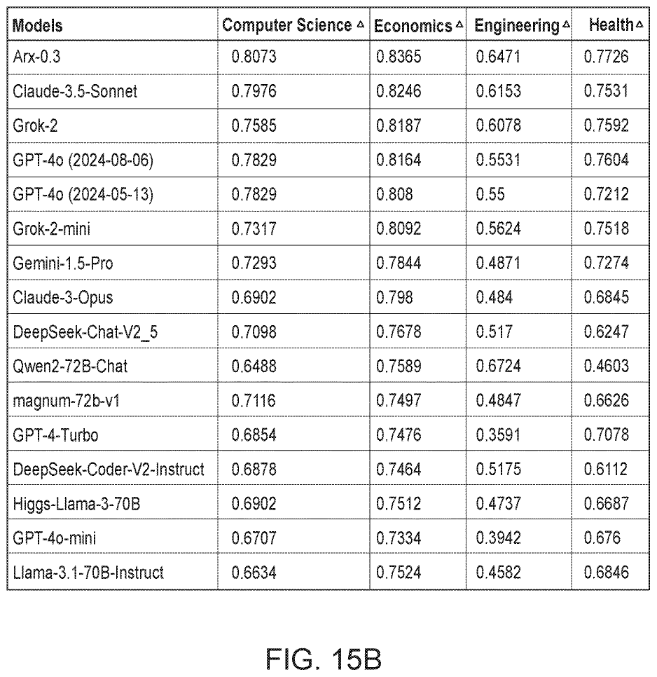

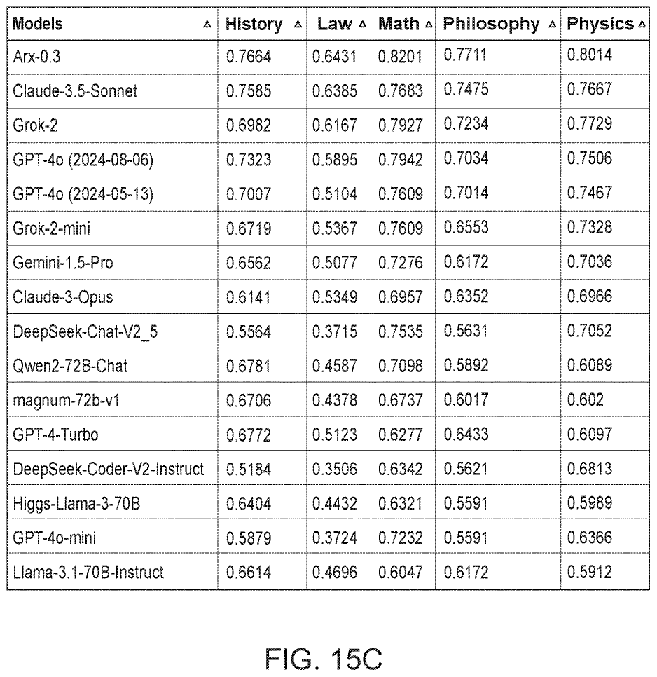

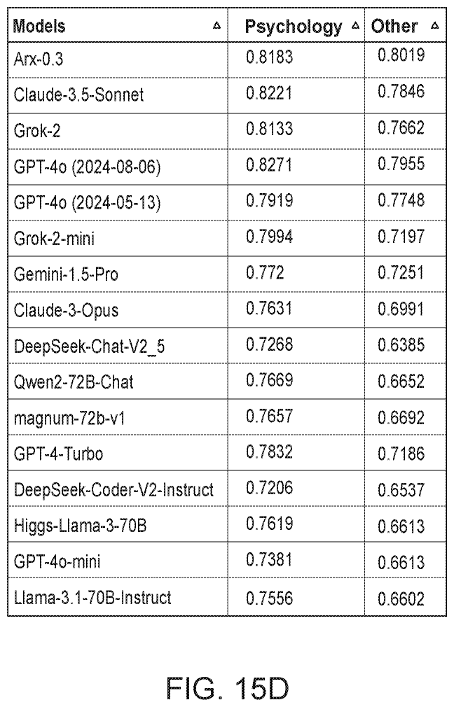

An implementation of the ULM discussed elsewhere herein was shown to outperform all competitors in overall performance on the MMLU-Pro (Massive Multitask Language Understanding) benchmark dataset. The MMLU-Pro dataset is used to compare language understanding models across a broad, diverse array of challenging tasks, providing questions ranging from elementary level to advanced professional level. The MMLU-Pro dataset is available to the public and has been evaluated against well-known models such as GPT-4o, Claude-3.5 Sonnet, and Llama 3.1 as shown in FIG. 15A-D. The MMLU-Pro dataset contains over 12,000 reasoning-focused questions and ten answer choices for most questions. The questions therein are curated from academic exams and textbooks, spanning 14 domains including biology, business, chemistry, computer science, engineering, health, history, law, math, philosophy, physics, psychology, and others.

The implementation of the ULM evaluated against the MMLU-Pro dataset achieved an overall score of 0.7824, the highest of any model, as shown in FIG. 15A. In addition to the top overall score, the implementation of the ULM presented herein performed better than each of the next ten top models in: business, computer science, economics, health, history, law, math, philosophy, physics, and other. Further, the implementation of the ULM presented herein performed better than all but one competitor in engineering and biology. The category by category performance of the ULM is shown in FIGS. 15A-D.

What is claimed is:

1. A computer-implemented method for enriching dynamic language graphs, the computer-implemented method comprising:
a) parsing an input in a language domain into an enriched tree data-structure, wherein the enriched tree data-structure comprises at least one of a unique identification of an entity, a classification, and a resolution;
b) processing the enriched tree data-structure by matching the enriched tree data-structure with one or more dynamic language graphs, wherein the one or more dynamic language graphs store a relation between elements of the language domain, a causation of a plurality of entities in the one or more dynamic language graphs, and a property of the plurality of entities in the one or more dynamic language graphs; and
c) upon determining the enriched tree data-structure does not match with the one or more dynamic language graphs, at least a portion of the enriched tree data-structure that does not match is inserted into the one or more dynamic language graphs.

2. The computer-implemented method of claim 1, wherein a language model comprising the one or more dynamic language graphs provides an overall score on an MMLU-Pro dataset of at least 0.78.

3. The computer-implemented method of claim 2, wherein the language model provides a score of at least 0.89 in biology, 0.81 in business, 0.80 in computer science, 0.84 in economics, 0.64 in engineering, 0.77 in health, 0.64 in law, 0.82 in math, 0.77 in philosophy, 0.80 in physics, 0.81 in psychology, or any combination thereof, on the MMLU-Pro dataset.

4. The computer-implemented method of claim 1, wherein the relation is defined as a tuple of entities and connections between entities.

5. The computer-implemented method of claim 1, wherein the entities are basic elements of an ontology of the language domain.

6. The computer-implemented method of claim 1, further comprising chunking the input into a plurality of chunks based at least in part on a dictionary model of the language domain.

7. The computer-implemented method of claim 6, further comprising parsing the plurality of chunks using an initial grammar rule.

8. The computer-implemented method of claim 1, further comprising providing a grounded response for the input.

9. The computer-implemented method of claim 8, wherein the grounded response comprises one or more sources of verification.

10. The computer-implemented method of claim 9, wherein a source of the one or more sources of verification comprises program documentation or an employee manual.

11. The computer-implemented method of claim 8, wherein the providing the grounded response for the input comprises determining a question style, a theme, an entity, a domain, a task, a difficulty, a time sensitivity, a presumption, or any combination thereof, of the input.

12. The computer-implemented method of claim 8, wherein the grounded response comprises a link to a source of the one or more sources of verification.

13. The computer-implemented method of claim 1, wherein the language model comprises a universal learning mechanism.

14. The computer-implemented method of claim 1, further comprising receiving the input from a user device.

15. The computer-implemented method of claim 1, wherein the at least the portion of the enriched tree data-structure inserted into the one or more dynamic language graphs comprises a new grammar rule, a new causation between entities, a new property, or a new relationship.

16. The computer-implemented method of claim 1, wherein the one or more dynamic language graphs comprise representations of one or more causations of each of the plurality of entities, wherein the representations comprise a provenance of each of the plurality of entities, properties of each of the plurality of entities, or relationships among each of the plurality of entities.

17. The computer-implemented method of claim 1, further comprising determining that the tree data-structure does not match based at least in part on TOE logic.

18. The computer-implemented method of claim 1, further comprising selecting a dynamic language graph in which to insert the at least the portion of the enriched tree data-structure.

19. A computer system, comprising:
at least one processor; and
non-transitory computer readable storage media encoded with a computer program that causes the processor to perform operations comprising:
a) parsing an input in a language domain into an enriched tree data-structure, wherein the enriched tree data-structure comprises at least one of a unique identification of an entity, a classification, and a resolution;
b) processing the enriched tree data-structure by matching the enriched tree data-structure with one or more dynamic language graphs, wherein the one or more dynamic language graphs store a relation between elements of the language domain, a causation of a plurality of entities in the one or more dynamic language graphs, and a property of the plurality of entities in the one or more dynamic language graphs; and
c) upon determining the enriched tree data-structure does not match with the one or more dynamic language graphs, at least a portion of the enriched tree data-structure that does not match is inserted into the one or more dynamic language graphs.

20. A non-transitory computer-readable storage media encoded with a computer program including instructions executable by a processor to create an application, the application configured to perform operation comprising:
a) parsing an input in a language domain into an enriched tree data-structure, wherein the enriched tree data-structure comprises at least one of a unique identification of an entity, a classification, and a resolution;
b) processing the enriched tree data-structure by matching the enriched tree data-structure with one or more dynamic language graphs, wherein the one or more dynamic language graphs store a relation between elements of the language domain, a causation of a plurality of entities in the one or more dynamic language graphs, and a property of the plurality of entities in the one or more dynamic language graphs; and
c) upon determining the enriched tree data-structure does not match with the one or more dynamic language graphs, at least a portion of the enriched tree data-structure that does not match is inserted into the one or more dynamic language graphs.
